(19) United States
(12) Patent Application Publication
(10) Pub. No.: US 2025/0209527 A1
(43) Pub. Date: Jun. 26, 2025

(54) METHOD OF PROVIDING AN APPROVAL PROCESS FOR POTENTIAL RESIDENTIAL NET LEASES

(71) Applicant: Capview Partners, LLC, Dallas, TX (US)

(72) Inventors: John Hammill, Dallas, TX (US); Kevin Connelly, Dallas, TX (US); Danilo da Silva, Dallas, TX (US)

(21) Appl. No.: 19/000,381

(22) Filed: Dec. 23, 2024

Related U.S. Application Data
(60) Provisional application No. 63/614,846, filed on Dec. 26, 2023.

(51) Int. Cl. G06Q 30/0645; G06N 3/08; G06Q 50/16

(52) U.S. Cl. CPC G06Q 30/0645; G06N 3/08; G06Q 50/16

(57) ABSTRACT

The present disclosure provides systems and methods for automating a residential net lease management tool that update net lease terms to minimize an overall risk level based on the predicted risk probabilities for risk factors. The automated creation, analysis, and management of residential net leases is provided, using machine learning models to minimize risk levels based on predicted risk probabilities. Market data is used to generate lease parameters, which are then applied to properties with their associated fixed and variable costs. A set of lease terms is generated, subjected to risk assessment, and optimized for overall risk minimization. Due diligence data and dynamic predictions of risk probabilities are updated in real-time to improve the accuracy of risk assessments, market predictions, financial projections, and checklist scores for approving lease terms. The system can be retrained with new extracted data to adapt to changing market conditions.

### CROSS-REFERENCE TO RELATED APPLICATIONS

This application claims priority from U.S. provisional application 63/614,846 filed Dec. 26, 2023 the disclosure of which is incorporated herein by reference.

### FIELD OF THE DISCLOSURE

The present disclosure is generally related to an approval process for potential residential net leases.

### BACKGROUND

Currently, the process for vetting potential prospects for net leases is difficult because of the amount of information that needs to be collected, analyzed, created, and reviewed. Also, there are challenges in determining if a potential property owner's property would be profitable if they were to be involved in a residential net lease. Lastly, an approval process to decide whether or not a property owner would be offered a residential net lease is required to ensure that the residential net lease accountings indicate profitability of the property. Thus, there is a need in the prior art to provide an approval process for potential residential net leases.

### SUMMARY

Disclosed are systems, apparatuses, methods, computer readable medium, and circuits for automating a residential net lease management tool that update net lease terms to minimize an overall risk level based on predicted risk probabilities for risk factors. According to at least one example, a method includes

In some cases, the method for automating a residential net lease management tool that update net lease terms to minimize an overall risk level based on the predicted risk probabilities for risk factors, includes receiving, over an expense network, market data associated with a specific region sent over a communication network at a net lease management server configured to communicate with at least one third-party application. In some cases, the method includes initiating, by a net lease module, a reserve module, and generating, by the reserve module, net lease parameters for the specific region based on a calculated profitability evaluation based on the market data received via the expense network, where the calculated profitability evaluation determines a threshold margin based on a percentage of an average rental rate and average fixed costs in the specific region.

In some cases, the method includes initiating, by the net lease module, an owner module, and identifying, by the owner module, properties that fall within the net lease parameters generated by the reserve module, initiating, by the net lease module, a manage module, determining, by the manage module, fixed costs and variable costs based on data associated with at least one of the identified properties and extracted data points from stored invoice data, generating, by the reserve module, a set of net lease terms associated with the at least one of the properties identified by the net lease module, based on first inputs including the fixed costs and variable costs determined the manage module, where first weights are assigned to each first input, receiving an approval from a property owner of the generated set of net lease terms.

In some cases, the method includes initiating, by the net lease module, a risk module, and inputting, in a first machine-learning model of the risk module, due diligence data of the property owner and the identified properties and the generated set of net lease terms, predicting, by the first machine-learning model, a plurality of risk probabilities associated with respective risk factors, running a gradient-based optimization process of the first machine-learning model to identify one or more combinations of net lease terms that minimize an overall risk level based on the predicted risk probabilities for the respective risk factors, and updating the generated net lease terms with changes based on the identified one or more combinations of net lease terms.

In another example, a system for automating a residential net lease management tool that update net lease terms to minimize an overall risk level based on the predicted risk probabilities for risk factors is provided that includes a storage (e.g., a memory configured to store data, such as virtual content data, one or more images, etc.) and one or more processors (e.g., implemented in circuitry) coupled to the memory and configured to execute instructions and, in conjunction with various components (e.g., a network interface, a display, an output device, etc.), cause the system to automate a residential net lease management tool that update net lease terms to minimize an overall risk level based on predicted risk probabilities for risk factors. The system may comprise a storage configured to store instructions, a net lease module that controls a reserve module, an owner module, a manage module, and a risk module, the reserve module that generates a plurality of net lease parameters for different regions, the owner module that identifies replacement properties that fall within a particular net lease parameter, the manage module that determines fixed costs and variable costs, and the risk module that identifies prospective net lease terms that minimize an overall risk level based on predicted risk probabilities for respective risk factors.

In some cases, the instructions cause the system to receive, over an expense network, market data associated with a specific region sent over a communication network at a net lease management server configured to communicate with at least one third-party application.

In some cases, the instructions cause the system to initiate, by the net lease module, the reserve module and generate, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;

In some cases, the instructions cause the system to initiate, by the net lease module, the owner module and identify, by the owner module, properties that fall within the net lease parameters generated by the reserve module. In some cases, the instructions cause the system to initiate, by the net lease module, the manage module and determine, by the manage module, fixed costs and variable costs based on data associated with at least one of the identified properties and extracted data points from stored invoice data, and generate, by the reserve module, a set of net lease terms associated with the at least one of the properties identified by the net lease module, based on inputs including the fixed costs and variable costs determined the manage module, wherein weights are assigned to each input.

In some cases, the instructions cause the system to receive an approval from a property owner of the generated set of net lease terms, initiate, by the net lease module, the risk module, input, in a first machine-learning model of the risk module, due diligence data of the property owner and the identified properties and the generated set of net lease terms, and predict, by the first machine-learning model, a plurality of risk probabilities associated with respective risk factors. In some cases, the instructions cause the system to run a gradient-based optimization process of the first machine-learning model to identify one or more combinations of net lease terms that minimize an overall risk level based on the predicted risk probabilities for the respective risk factors and update the generated net lease terms with changes based on the identified one or more combinations of net lease terms.

### BRIEF DESCRIPTION OF THE SEVERAL VIEWS OF THE DRAWINGS

Aspects of the present disclosure will be described more fully hereinafter with reference to the accompanying drawings in which like numerals represent like elements throughout the several figures, and in which example aspects of this disclosure are shown. Aspects of the claims may, however, be embodied in many different forms and should not be construed as limited to the aspects as set forth herein. The examples set forth herein are non-limiting examples and are merely examples among other possible examples.

FIG. 1 illustrates a system for providing a method of providing an approval process for potential residential net leases.

FIG. 2 illustrates an example method performed by a net lease module.

FIG. 3 illustrates an example method performed by a reserve module.

FIG. 4 illustrates an example method performed by an owner module.

FIG. 5 displays an example method performed by an underwrite module, a diligence module, and a market module.

FIG. 6 illustrates an example method performed by a financial module and a checklist module.

FIG. 7 displays an example method performed by a risk module.

FIG. 8 illustrates an example method performed by an investor module.

FIG. 9 illustrates an example method performed by a manage module.

FIG. 10 illustrates a block diagram of an exemplary computing system that may be used to implement an embodiment of the present invention.

FIG. 11 illustrates an example neural network architecture.

### DETAILED DESCRIPTION

Embodiments of the present disclosure will be described more fully hereinafter with reference to the accompanying drawings in which like numerals represent like elements throughout the several figures and in which example embodiments are shown. Embodiments of the claims may, however, be embodied in many different forms and should not be construed as limited to the embodiments set forth herein. The examples set forth herein are non-limiting examples and are merely examples among other possible examples.

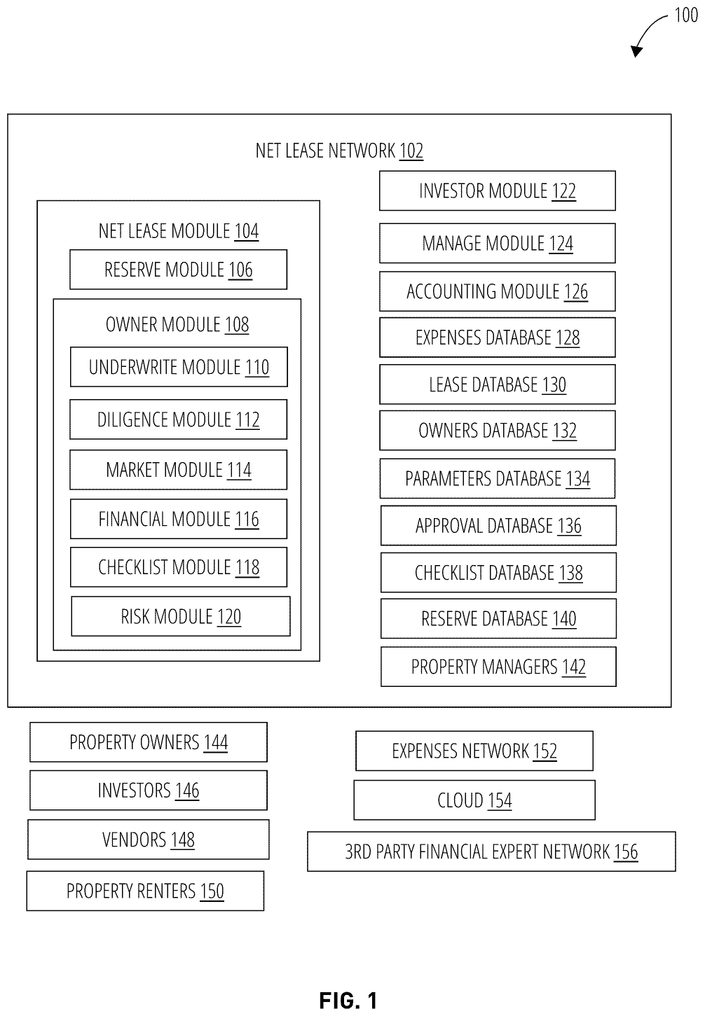

FIG. 1 illustrates a net lease system 100 that provides an approval process for potential residential net leases. The net lease system 100 comprises a net lease network 102, which may be a software system or process to calculate a long-term, net lease accounting to property owners 144 of residential rental properties for a 15 to 25-year primary term and provides landlords with more net operating income for the first five to nine years in exchange for an up-front initial lease reserve fee that in combination with rents received from renters, allows the lessee to absorb all property level expenses and meet the agreed terms of the lease and account for all net lease amounts due. The absolute net lease means that the lessee owes the landlord (lessor) a fixed lease amount according to a lease commitment schedule in exchange for full control and uninterrupted rights to the property as if it were owned by the lessee for the period of the primary lease term and any renewal options it executes. These rights include the right to rent the property to sub-tenants/renters to generate rental income. The lessee is responsible for all property-level expenses including, but not limited to, taxes, insurance, maintenance, utilities, capital expenditures, replacement and repair of FF&E and real property, management, etc.

The net lease system 100 may further include a net lease module 104, which begins by connecting to the expenses network 152. The net lease module 104 receives the data from the expenses network 152. The net lease module 104 stores the data from the expenses network 152 in the expenses database 128. The net lease module 104 initiates the reserve module 106. The net lease module 104 initiates the owner module 108. The net lease module 104 initiates the investor module 122. The net lease module 104 filters the owners database 132 on approved property owners 144. For example, the net lease module 104 filters the owners database 132 on property owners 144 that have been approved from the checklist module 118, which analyzes the data collected from underwrite module 110, diligence module 112, market module 114, and financial module 116 to ensure that property owner 144 would be a strong candidate for a residential net lease. The net lease module 104 extracts the first owner from the owners database 132. The net lease module 104 connects to the vendors 148. The net lease module 104 determines the fixed and variable costs for the property. The net lease module 104 creates the net lease terms for the property owner.

The net lease module 104 determines if the property owner 144 approved the net lease terms. If it is determined that the property owner 144 approved the net lease terms, the net lease module 104 assigns a property manager 142 to the property. The net lease module 104 stores the data in the lease database. If it is determined that the property owner 144 did not approve of the net lease terms or after the data is stored in the lease database 130, the net lease module 104 determines if there are any property owners 144 remaining in the owners database 132. If it is determined that more owners are remaining in the owners database 132, the net lease module 104 extracts the next owner from the owners database 132, and the process returns to connecting to the vendors 148. If it is determined that there are no more owners remaining in the owners database 132, the net lease module 104 initiates the manage module 124. Then the net lease module 104 initiates the accounting module 126, and the process returns to connecting to the expenses network 152. The net lease module 104 determines if the predetermined time period has passed. If it is determined that the predetermined time period has not passed, the net lease module 104 returns to connecting to the expenses network 152. If it is determined that the predetermined time period has passed, the net lease module 104 initiates the underwrite module 110.

The net lease system 100 may further include a reserve module 106 that begins by being initiated by the net lease module 104. The reserve module 106 extracts the first region from the expenses database 128. The reserve module 106 determines if risk factors were received from the risk module 120 for the region. If it is determined that there are risk factors for the region the reserve module 106 receives the risk factors from the risk module 120. If it is determined that there are no risk factors for the region or after the risk factors are received from the risk module 120, the reserve module 106 creates the parameters for the net lease for the region. The reserve module 106 stores the parameters in the parameters database 134. The reserve module 106 determines if there are any more regions remaining in the expenses database 128. If it is determined that more regions are remaining in the expenses database 128, the reserve module 106 extracts the next region from the expenses database 128, and the process returns to creating the parameters for the net lease for the region. If it is determined that there are no more regions remaining in the expenses database 128, the reserve module 106 returns to the net lease module 104.

The net lease system 100 may further include an owner module 108, which begins by being initiated by the net lease module 104. The owner module 108 connects to the property owners 144. The owner module 108 identifies the potential property owners that may have a property that is within the parameters for a net lease. The owner module 108 sends a notification to the property owners 144 with a property that fulfills the parameters for a net lease. The owner module 108 determines if the owner approved the notification. If the owner approves the notification, the owner module 108 receives the property details from the property owner 144.

The owner module 108 stores the data in the owners database 132. The owner module 108 initiates the underwrite module 110. If it is determined that the owner did not approve the notification or after the data is stored in the owners database 132, the owner module 108 returns to the net lease module 104.

The net lease system 100 may further include an underwrite module 110, which begins by being initiated by the owner module 108 or the net lease module 104. The underwrite module 110 extracts the property owner 144 data from the owners database 132. The underwrite module 110 connects to the 3rd party financial expert network 156. The underwrite module 110 sends the extracted property owner 144 data from the owners database 132 to the 3rd party financial expert network 156. The underwrite module 110 receives the property owner 144 data from the 3rd party financial expert network 156. The underwrite module 110 stores the received property owner 144 data from the 3rd party financial expert network 156 in the approval database 136. The underwrite module 110 initiates the diligence module 112.

The net lease system 100 may further include a diligence module 112 that begins by being initiated by the underwrite module 110. The diligence module 112 connects to the vendors 148. The diligence module 112 extracts the property owner 144 data from the owners database 132. The diligence module 112 sends the property owner 144 data to the vendor 148. The diligence module 112 receives the diligence report from the vendor 148. The diligence module 112 stores the diligence report from the vendor 148 in the approval database 136. The diligence module 112 initiates the market module 114.

The net lease system 100 may further include a market module 114, which begins by being initiated by the diligence module 112. The market module 114 extracts the property location from the owners database 132. The market module 114 compares the extracted property location from the owners database 132 to the expenses database 128. The market module 114 extracts the location data from the expenses database 128. The market module 114 stores the location data in the approval database 136. The market module 114 initiates the financial module 116.

The net lease system 100 may further include a financial module 116, which begins by being initiated by the market module 114. The financial module 116 extracts the property owner 144 data from the owners database 132. The financial module 116 extracts the data from the approval database 136. The financial module 116 generates the financial projections for the property. The financial module 116 stores the financial projections in the approval database 136. The financial module 116 initiates the checklist module 118. The net lease system 100 may further include a checklist module 118, which begins by being initiated by the financial module 116. The checklist module 118 extracts the data from the approval database 136. The checklist module 118 compares the data from the approval database 136 to the checklist database 138. The checklist module 118 extracts the corresponding rule from the checklist database 138. The checklist module 118 determines if the property was approved for a residential net lease. If it is determined that the property was approved for a residential net lease, the checklist module 118 stores that the property is approved in the owners database 132. If it is determined that the property was not approved for a residential net lease, the checklist module 118 stores that the property was not approved in the owners database 132. The checklist module 118 initiates the risk module 120.

The net lease system 100 may further include a risk module 120, which begins by being initiated by the checklist module 118. The risk module 120 filters the owners database 132 on the approved property owners 144. The risk module 120 extracts the first approved property owner 144 from the owners database 132. The risk module 120 filters the approval database 136 and the lease database 130 on the approved property owner 144. The risk module 120 extracts the data from the approval database 136 and the lease database 130. The risk module 120 determines the property owner's 144 current status. The risk module 120 stores the property owner's 144 current status in the owners database 132. The risk module 120 determines if the property owner's 144 current status is negative. If it is determined that the property owner's 144 current status is negative, the risk module 120 determines the risk factors for the property's region. The risk module 120 sends the risk factors for the region to the reserve module 106. If it is determined that the property owner's 144 current status is not negative or after the risk module 120 sends the risk factors for the region to the reserve module 106, the risk module 120 determines if there are more approved property owners 144 in the owners database 132. If it is determined that there are more approved property owners 144 stored in the owners database 132, the risk module 120 extracts the next approved property owner 144, and the process returns to filtering the approval database 136 and the lease database 130. If it is determined that there are no more approved property owners 144 remaining in the owners database 132, the risk module 120 returns to the net lease module 104. The net lease system 100 may further include an investor module 122, which begins by being initiated by the net lease module 104. The investor module 122 connects to the investors 146. The investor module 122 identifies potential investors for investment into the reserve database 140. The investor module 122 sends a notification to the investors 146. The investor module 122 receives the investment from the investors 146. The investor module 122 stores the received investment from the investors 146 in the reserve fund 24. The investor module 122 returns to the net lease module 104.

The net lease system 100 may further include a manage module 124, which begins by being initiated by the net lease module 104. The manage module 124 extracts the first data entry in the lease database 130. The manage module 124 determines the fixed and variable costs for the property. The manage module 124 pays the costs of the property. The manage module 124 collects rent from the renters 150. The manage module 124 stores the rent in the reserve database 140. The manage module 124 determines if there are more data entries remaining in the lease database 130. If it is determined that there are more data entries in the lease database 130, the manage module 124 extracts the next data entry from the lease database 130. If it is determined that there are no more data entries remaining in the lease database 130, the manage module 124 returns to the net lease module 104.

The net lease system 100 may further include a accounting module 126, which begins by being initiated by the net lease module 104. The accounting module 126 determines the commitment to the property owners 144. The accounting module 126 records the accounting to the property owners 144. The accounting module 126 determines the profits of the residential investments. The accounting module 126 sends the profits of the residential investments to the investors 146. The accounting module 126 returns to the net lease module 104.

The net lease system 100 may further include an expenses database 128, which contains the location of where the market data is for, the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the home owners association fees, the cost of utilities, and the asset management fees. In some embodiments, the market data may be for a specific location or region or may be specific to a certain property location. In some embodiments, each of the data points stored in the database may be used as an input into an algorithm to determine the net lease terms for the property owner 144, determine the rent for the specific property, and determine the profits or return on investment for the investors 146. In some embodiments, the starting market price may be the cost per square footage, the average cost of rent in a certain location, the average cost of rent in a certain location based on the number of bedrooms, the average cost of rent in a certain region of a city or town, etc. In some embodiments, the net lease module 104 may send a request to the expenses network 152 to receive relevant data points for a specific property location, for example, by using the mailing address.

The net lease system 100 may further include an lease database 130, which contains a property owner ID, the property ID, the length of the lease or the years remaining on the net lease, the lease commitment to the property owner 144, the annual increase of the net lease commitment to the property owner, the fixed and variable costs per month for the property, the rent collected per month for the property, and the monthly profits for the property. In some embodiments, a property owner 144 may have multiple properties under a net lease with the net lease network 102. In some embodiments, the fixed and variable costs may differ for each property, or if there are multiple properties located within a certain radius, there may be one vendor 148 and/or one property manager 142 for each of the properties to lower the monthly fixed and variable costs. In some embodiments, the database may be shown as monthly, quarterly, or annual commitments, expenses, profits, etc. In some embodiments, the investors 146 may receive a percentage of the monthly profits or may be paid out based on quarterly or annual profits.

The net lease system 100 may further include an owners database 132, which contains the owners interested in receiving a net lease terms from the net lease network 102. The database contains the owner's name, the owner ID, the property ID, the property address, the square footage, the number of bedrooms, the number of bathrooms if the property or property owner 144 is approved for a residential net lease, and the property owner's 144 current status. In some embodiments, the owner may send the net lease network 102 more data on the location, such as average utility bills, property tax, insurance costs, condition of the property, condition of current appliances, etc. In some embodiments, the owner may send the net lease network 102 the current rates they charge for rent, if the property is vacant or if it currently has renters, the application process the owner uses for renters, etc. In some embodiments, the approval status may be based on a per-property basis or on a per-property owner 144 basis. In some embodiments, the property owner's 144 current status may be the status of the investment of the residential net lease, including the profitability of the property, the overall revenue generated by the property, the fixed and variable costs of the property compared to similar properties in the region, cost of utility bills of the property compared to similar properties in the region, property tax of the property compared to similar properties in the region, insurance costs of the property compared to similar properties in the region, condition of the property compared to similar properties in the region, condition of current appliances of the property compared to similar properties in the region, etc.

The net lease system 100 may further include a parameters database 134, which contains the parameters created during the process described in the reserve module 106 that are used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some embodiments, the database may contain a plurality of locations based on the region of the country, the state the property resides in, the city where the property is located, the town or section of a city the property is located, etc. In some embodiments, the parameters may be determined by the property's square footage, the number of bedrooms the property has, the rent that may be charged for the residential property, or a combination of the parameters.

The net lease system 100 may further include an approval database 136, which contains the data collected by the underwrite module 110, diligence module 112, market module 114, and financial module 116, which is used to determine if a property owner 144 or property is approved for a residential net lease. The database contains the property owner's 142 name, the property owner's 142 ID, the property ID, the underwriting data, such as the property owner's 142 credit score, debt to income ratio, employment verification, income verification, etc., the due diligence, data such as repair estimates, property insurance, etc. the market data, such as the starting market rent per square foot, the growth rate, the inflation rate, the vacancy rate, the rent collectability rate, etc. and the financial projections, such as a range for lease commitments to the property owner 144, a range for a yearly lease commitment increase, a range of fixed and variable costs, a range of rent that may be charged for the property, and a range of potential monthly profits, etc. In some embodiments, the property owner 144 data may include the property owner's 142 address, job title, employer, number of properties owned, etc. In some embodiments, the property data may include the property address, the square footage, the number of bedrooms, the number of bathrooms, average utility bills, property tax, insurance costs, condition of the property, condition of current appliances, the current rates they charge for rent, if the property is vacant or if it currently has renters, the application process the owner uses for renters, etc.

In some embodiments, the underwriting data may include an appraisal from a 3rd party, the amount of money in a savings account or a plurality of savings accounts, and the 3rd party financial expert network 156 that was used for the underwriting process. In some embodiments, the underwriting process may be performed on the renters 150 of the property. In some embodiments, the due diligence data may include a value projection, a location assessment, parking at the property, a physical inspection performed by a property manager 142, the homeowner's association rules, an appraisal, an examination of the title of the property, etc. In some embodiments, the market data may include the local taxes, insurance rates, management fees, the maintenance budget, the homeowner's association fees, the cost of utilities, asset management fees, etc. In some embodiments, the financial projections may be based on a monthly, quarterly, or yearly basis. In some embodiments, the financial projections may include an estimate of the total investment required for the property, potential returns on the investment for individual investors, year-to-year return on investment, etc.

The net lease system 100 may further include a checklist database 138, which contains the requirements for the property owner's 142 property or properties to be approved to be offered a residential net lease from the net lease network 102. The database contains a series of requirements and a corresponding rule if the requirement is met or not. For example, the data stored in the approval database 136 is compared to the checklist database 138, such as the property owner's 142 credit score is extracted and compared to the checklist database 138 in which if the property owner's 142 credit score is above 650 then the rule would be to check the next requirement which would be if the property owner's 142 debt to income ratio is below 35%. If the property owner's 142 credit score is below 650, then the corresponding rule would be to not approve of the property owner 144 for a residential net lease and would be stored in the owners database 132. In some embodiments, the requirements may be predetermined thresholds set by an administrator of the net lease network 102. In some embodiments, the requirements may include rules for the property owner's 142 credit score, debt to income ratio, employment verification, income verification, repair estimates, property insurance, the starting market rent per square foot, the growth rate, the inflation rate, the vacancy rate, the rent collectability rate, a range for lease commitments to the property owner 144, a range for a yearly lease commitment increase, a range of fixed and variable costs, a range of rent that may be charged for the property, and a range of potential monthly profits, the square footage, the number of bedrooms, the number of bathrooms, average utility bills, property tax, insurance costs, condition of the property, condition of current appliances, the current rates they charge for rent, if the property is vacant or if it currently has renters, the application process the owner uses for renters, amount of money in savings account or plurality of savings accounts, a value projection, a location assessment, parking at the property, a physical inspection performed by a property manager 142, the homeowner's association rules, an appraisal, an examination of the title of the property, the local taxes, the insurance rates, the management fees, the maintenance budget, the homeowner's association fees, the cost of utilities, the asset management fees, etc.

In some embodiments, the property owner may be required to meet all of the requirements of the checklist database 138 to be offered a residential net lease. In some embodiments, the property owner 144 may be required to meet a certain percentage of the requirements in the checklist database 138 to be offered a residential net lease, such as 90% of the requirements, 80% of the requirements, 70% of the requirements, etc. In some embodiments, the requirements may be associated with a weighted scoring system, and the property owner 144 would be required to meet a certain score to be offered a residential net lease. For example, each requirement would be given a weighted score, such as having a good credit score and debt-to-income ratio would result in a higher score than the number of bathrooms in a property or the number of parking spots. The property owner's 142 data stored in the approval database 136 would be compared to the checklist database 138 to determine the property owner's 142 score, and if above a predetermined threshold, the property owner 144 would be offered a residential net lease.

The net lease system 100 may further include a reserve database 140 in which the investors 146 investment is stored as capital in the event that the net lease networks 102 expenses are greater than the returns, or profits from the residential rental properties, to ensure amount remunerated to the property owners 144 according to the terms of their net lease. The reserve database 140 may also be used to expand a line of credit for the net lease network 102 to add more residential rental properties to the lease database by attracting more property owners 144. The reserve database 140 may extend debt as an investment to get a return on funds. In some embodiments, the reserve database 140 may be stored and managed by a third party, such as a bank or financial institution. In some embodiments, the reserve database 140 may be used for unexpected costs such as unexpected vacancy of the residential rental property, capital expenditures, variable costs, etc.

The net lease system 100 may further include a plurality of property managers 142, which may be a person or firm charged with operating a real estate property for a fee. For example, the property manager 142 may be required to find/evict tenants, deal with tenants, and coordinate with the net lease network 102. In addition, such arrangements may require the property manager 142 to collect rent and pay necessary expenses and taxes, making periodic reports to the owner, or the net lease network 102 may delegate specific tasks and deal with others directly. A property manager 142 may arrange for a wide variety of services, as may be requested by the net lease network 102, for a fee. Where a dwelling (vacation home, second home) is only periodically occupied, the property manager 142 might arrange for heightened security monitoring, house-sitting, storage and shipping of goods, and other local sub-contracting necessary to make the property comfortable for when a new tenant rents the property.

The net lease system 100 may further include a plurality of property owners 144, which may be residential property owners that engage in a long-term net lease with the net lease network 102 to eliminate variability that comes with renting residential properties and decrease the time spent on making the residential rental property profitable. The long-term net lease with the net lease network 102 allows the property owner 144 to remove themselves from the responsibility of managing the property, paying taxes on the property, paying insurance on the property, maintaining the property, paying for utilities, paying for capital expenditures of the property, etc. and moving the responsibility to the net lease network 102 in exchange for net lease commitment allowing the net lease network 102 controlling rights of the property.

The net lease system 100 may further include a plurality of investors 146, which provide an investment to the net lease network 102 to find residential properties to engage in long-term net leases in exchange for a percentage of the profits made on the residential properties as the return on the investment. The net lease system 100 may further include a plurality of vendors 148, which may be the source of where the property managers 142 are assigned to the various residential rental properties and take care of the management of the property, management of the leases for the tenants, manage the maintenance of the property, track and collect rent from the tenants, track and maintain the relationship with the tenants, and manage the vacancy of the residential property.

The net lease system 100 may further include a plurality of property renters 150, which sign a rental agreement with the net lease network 102 to rent the residential property. The renters 150 may pay a monthly rental fee to live in the property, and the agreement may cover certain costs, such as heat, water, electricity, internet, etc. In some embodiments, the net lease network 102 may use a plurality of vendors 148 to assign property managers 142 to the residential rental property to take care and maintain the property on behalf of the net lease network 102 while collecting rent fees, paying fixed and variable costs, and maintain the relationship with the renters 150.

The net lease system 100 may further include an expenses network 152, which includes a plurality of market data for the properties engaged or about to be engaged in a long-term net lease with the net lease network 102. The expenses network 152 may contain data for specific locations, cities, regions, or states to allow the most up-to-date market data for the net lease network 102 to use to create the net lease terms. The expenses network 152 may contain, for each specific location, the starting market rent, the market growth rate, the inflation rate, the vacancy rate, the rent collectability rate, the home price appreciation, and the operating expenses, which are stored as a data file and may contain the local taxes, the insurance rates, the management fees, the maintenance budget, the homeowner's association fees, the cost of utilities, and the asset management fees. In some embodiments, the expenses network 152 may be connected to a plurality of third-party networks to compile the market data. In some embodiments, the expenses network 152 may continuously update the market data or may collect the specific market data based on a request from the net lease network 102. In some embodiments, the expenses network 152 may store the market data in a plurality of databases to extract and send the data as it is requested from the net lease network 102.

The net lease system 100 may further include a cloud 154, which is a distributed network of computers comprising servers and databases. A cloud 154 may be a private cloud 154, where access is restricted by isolating the network, preventing external access, or using encryption to limit access to only authorized users. Alternatively, a cloud 154 may be a public cloud 154 where access is widely available via the internet. A public cloud 154 may not be secured or include limited security features. The net lease system 100 may further include a 3rd party financial expert 156 which may be a company, service, or individual that performs the underwriting process of investigating a property owner's 142 credit history, verifying their income to debt ratio, verifying their employment, verifying their income, ordering or performing an appraisal to determine the value of the home, etc. In some embodiments, the 3rd party financial expert 156 may receive the property owner's 142 data from the underwrite module 110 and then proceed to collect the information about the property owner 144 and send the collected information back to the underwrite module 110.

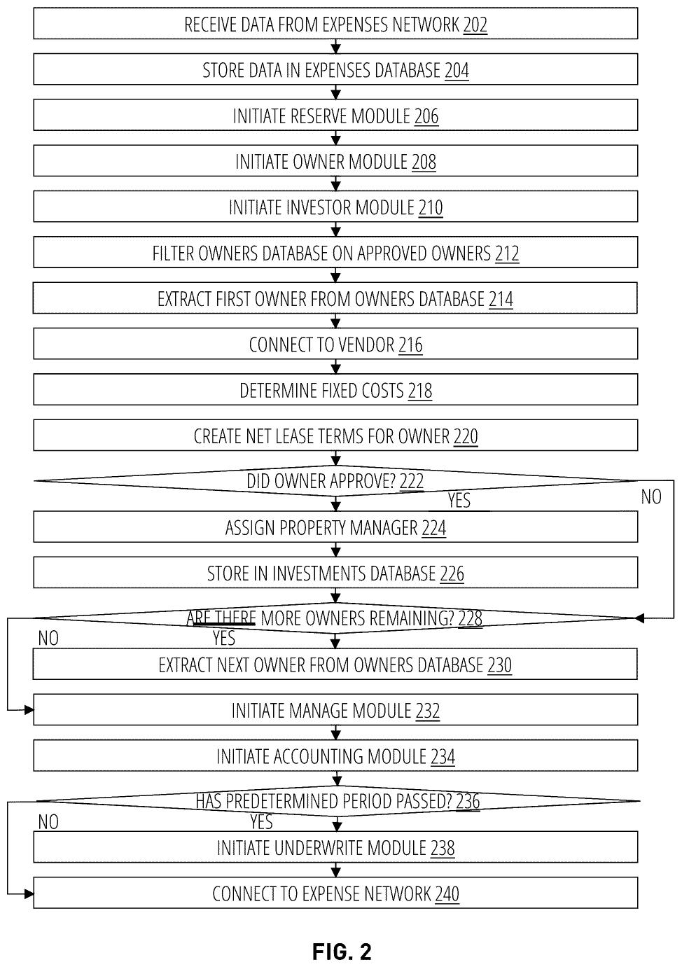

FIG. 2 displays an example method performed by the net lease module 104. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the net lease module 104 connecting to the expenses network 152. For example, the net lease module 104 connects to the expenses network 152 through the cloud 154. In some embodiments, the connection may include a request from the net lease module 104 to receive the market data stored in the expenses network 152. In some embodiments, if the expenses network 152 connects to a plurality of third-party networks for the market data, the net lease module 104 may connect to each third-party network to request the market data individually. In some embodiments, the request from the net lease module 104 may include a specific location, city, region, state, etc., for the desired market data. The net lease module 104 receives, at step 202, the data from the expenses network 152. For example, the net lease module 104 receives the market data from the expenses network 152, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

The net lease module 104 stores, at step 204, the data from the expenses network 152 in the expenses database 128. For example, the net lease module 104 stores the market data in the expenses database 128, such as the starting market rent, the market growth rate, the inflation rate, the vacancy rate, the rent collectability rate, the home price appreciation, the operating expenses which are stored as a data file and may contain the local taxes, the insurance rates, the management fees, the maintenance budget, the homeowner's association fees, the cost of utilities, and the asset management fees.

The net lease module 104 initiates, at step 206, the reserve module 106. For example, the reserve module 106 begins by being initiated by the net lease module 104. The reserve module 106 extracts the first region from the expenses database 128. The reserve module 106 determines if risk factors were received from the risk module 120 for the region. If it is determined that there are risk factors for the region, the reserve module 106 receives the risk factors from the risk module 120. If it is determined that there are no risk factors for the region or after the risk factors are received from the risk module 120, the reserve module 106 creates the parameters for the net lease for the region. The reserve module 106 stores the parameters in the parameters database 134.

The reserve module 106 determines if there are any more regions remaining in the expenses database 128. If it is determined that more regions remain in the expenses database 128, the reserve module 106 extracts the next region from the expenses database 128, and the process returns to creating the parameters for the net lease for the region. If it is determined that there are no more regions remaining in the expenses database 128, the reserve module 106 returns to the net lease module 104. The net lease module 104 initiates, at step 208, the owner module 108. For example, the owner module 108 begins by being initiated by the net lease module 104. The owner module 108 connects to the property owners 144. The owner module 108 identifies the potential property owners that may have a property that is within the parameters for a net lease. The owner module 108 sends a notification to the property owners 144 with a property that fulfills the parameters for a net lease. The owner module 108 determines if the owner approved the notification. If the owner approves the notification, the owner module 108 receives the property details from the property owner 144. The owner module 108 stores the data in the owners database 132. The owner module 108 initiates the underwrite module 110. If it is determined that the owner did not approve the notification or after the data is stored in the owners database 132, the owner module 108 returns to the net lease module 104.

The net lease module 104 initiates, at step 210, the investor module 122. For example, the investor module 122 begins by being initiated by the net lease module 104. The investor module 122 connects to the investors 146. The investor module 122 identifies potential investors for investment into the reserve database 140. The investor module 122 sends a notification to the investors 146. The investor module 122 receives the investment from the investors 146. The investor module 122 stores the received investment from the investors 146 in the reserve fund 24. The investor module 122 returns to the net lease module 104. The net lease module 104 filters, at step 212, the owners database 132 on approved property owners 144. For example, the net lease module 104 filters the owners database 132 on property owners 144 that have been approved from the checklist module 118, which analyzes the data collected from underwrite module 110, diligence module 112, market module 114, and financial module 116 to ensure that property owner 144 would be a strong candidate for a residential net lease.

The net lease module 104 extracts, at step 214, the first owner from the owners database 132. For example, the net lease module 104 extracts the data entry for the first owner and the first property for the owner, such as the property's location, the square footage, the number of bedrooms, and the number of bathrooms. In some embodiments, the data may include the average cost of utilities, property tax, insurance costs, condition of the property, condition of current appliances, the current rates they charge for rent, if the property is vacant or if it currently has renters, the application process the owner uses for renters, etc. The net lease module 104 connects, at step 216, to the vendors 148. For example, the net lease module 104 connects to the vendors 148 through the cloud 154 to find the average fixed and variable costs for the vendors in the region, city, state, etc., the property is located in. In some embodiments, the net lease module 104 may have a plurality of agreements with a plurality of vendors 148 in a plurality of locations to assign property managers to maintain the residential properties. The net lease module 104 determines, at step 218, the fixed and variable costs for the property. For example, the net lease module 104 may determine the fixed and variable costs for each property, such as by invoices inputted by vendors 148 or by the property managers 142, extracting the operating expenses from the expenses database 128, etc.

The net lease module 104 creates, at step 220, the net lease terms for the property owner. For example, the net lease module 104 may determine the residential property's location and then use the data stored in the expenses database 128 as inputs into an algorithm that outputs the net lease commitment terms for the property owner 144. For example, if the residential rental property is located in Boston, MA, then the starting market rent, the market growth rate, the inflation rate, the vacancy rate, the rent collectability rate, the home price appreciation, the operating expenses such as the local taxes, the insurance rates, the management fees, the maintenance budget, the home owners association fees, the cost of utilities, and the asset management fees would be used as inputs into the algorithm to determine the net lease commitment.

For example, the algorithm may use the average rent per square footage and the square footage of the property owners 144 residential property to determine the cost of rent for the property, such the average rent per square foot is $4.50 in Boston, MA, and the property owners 144 property is 800 square feet, resulting in a rent price of $3,600 per month. The other inputs, such as the market growth rate, the inflation rate, the vacancy rate, the rent collectability rate, the home price appreciation, the operating expenses, etc., may be used in the algorithm as weighted averages or percentages to increase or decrease the rental price of the property. The algorithm may offer the property owner 144 net lease terms based on a percentage of the possible rent that the net lease network 102 could charge tenants, such as 75% or $2,700 per month, over the length of 15 years, allowing the property owner 144 to be free of the responsibilities associated with renting a property and providing them with a steady commitment for the residential rental property. In some embodiments, the property owner 144 may be offered an annual increase percentage of the net lease commitment due to inflation, market growth rate, etc.

The net lease module 104 determines, at step 222, if the property owner 144 approved the net lease terms. For example, the property owner 144 may send the signed agreements back to the net lease module 104 or net lease network 102 to approve the net lease terms. In some embodiments, the property owner 144 may have a login, such as a username and a password, account, access to the net lease network 102, etc., to approve the net lease terms. In some embodiments, an administrator of the net lease network 102 may collect the signed agreements from the property owners 144 and store the data in the net lease network 102 to approve the net lease terms. If it is determined that the property owner 144 approved of the net lease terms, the net lease module 104 assigns, at step 224, a property manager 142 to the property. For example, the net lease module 104 may assign a property manager 142 to the residential property. In some embodiments, the property manager 142 may be assigned by one of the vendors 148 with which the net lease network 102 has an agreement. In some embodiments, the property manager 142 may be a person or firm charged with operating a real estate property for a fee. For example, the property manager 142 may be required to find/evict tenants, deal with tenants, and coordinate with the net lease network 102. In addition, such arrangements may require the property manager 142 to collect rents and pay necessary expenses and taxes, making periodic reports to the owner, or the net lease network 102 may delegate specific tasks and deal with others directly.

The net lease module 104 stores, at step 226, the data in the lease database. For example, the net lease module 104 stores the data created from the net lease terms in the lease database 130, such as a property owner ID, the property ID, the length of the lease or the years remaining on the net lease, the lease commitment to the property owner 144, the annual increase of the net lease commitment to the property owner, the fixed and variable costs per month for the property, the rent collected per month for the property, etc. If it is determined that the property owner 144 did not approve of the net lease terms or after the data is stored in the lease database 130, the net lease module 104 determines, at decision block 228, if there are any property owners 144 remaining in the owners database 132. If it is determined that more owners are remaining in the owners database 132, the net lease module 104 extracts, at step 230, the next owner from the owners database 132, and the process returns to connecting to the vendors 148.

If it is determined that no more owners are remaining in the owners database 132, the net lease module 104 initiates, at step 232, the manage module 124. For example, the manage module 124 begins by being initiated by the net lease module 104. The manage module 124 extracts the first data entry in the lease database 130. The manage module 124 determines the fixed and variable costs for the property. The manage module 124 pays the costs of the property. The manage module 124 collects rent from the renters 150. The manage module 124 stores the rent in the reserve database 140. The manage module 124 determines if there are more data entries remaining in the lease database 130. If it is determined that there are more data entries remaining in the lease database 130, the manage module 124 extracts the next data entry from the lease database 130. If it is determined that there are no more data entries remaining in the lease database 130, the manage module 124 returns to the net lease module 104.

Then the net lease module 104 initiates, at step 234, the accounting module 126, and the process returns to connecting to the expenses network 152. For example, the accounting module 126 begins by being initiated by the net lease module 104. The accounting module 126 determines the commitment to the property owners 144. The accounting module 126 accounts for the amount remunerated to the property owners 144. The accounting module 126 determines the profits of the residential investments. The accounting module 126 sends the profits of the residential investments to the investors 146. The accounting module 126 returns to the net lease module 104. The net lease module 104 determines, at step 236, if the predetermined time period has passed. If it is determined that the predetermined time period has not passed, the net lease module 104 returns to connecting to the expenses network 152. For example, the net lease module 104 may initiate the underwrite module 110 to determine if an approved property owner 144 residential net lease has been negatively affected, such as a decrease in profits, rentability, etc., since the beginning of the residential net lease. In some embodiments, the approved property owner 144 residential net lease may be reviewed on a predetermined time period, such as weekly, monthly, quarterly, yearly, etc.

If it is determined that the predetermined time period has passed, the net lease module 104 initiates, at step 238, the underwrite module 110. For example, the underwrite module 110 begins by being initiated by the owner module 108. The underwrite module 110 extracts the property owner 144 data from the owners database 132. The underwrite module 110 connects to the 3rd party financial expert network 156. The underwrite module 110 sends the extracted property owner 144 data from the owners database 132 to the 3rd party financial expert network 156. The underwrite module 110 receives the property owner 144 data from the 3rd party financial expert network 156. The underwrite module 110 stores the received property owner 144 data from the 3rd party financial expert network 156 in the approval database 136. The underwrite module 110 initiates the diligence module 112.

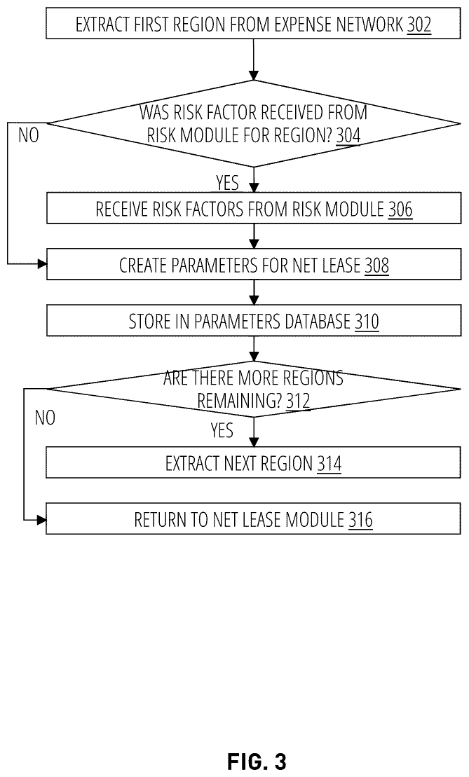

FIG. 3 displays an example method performed by the reserve module 106. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the reserve module 106 being initiated by the net lease module 104. In some embodiments, the reserve module 106 may not need to be initiated and is continuously running in the background of the net lease network 102. The reserve module 106 extracts, at step 302, the first region from the expenses database 128. For example, the reserve module 106 extracts the first region from the expenses database 128, such as the state, city, town, etc., that the expenses data and market data are related to.

The reserve module 106 determines, at step 304, if risk factors were received from the risk module 120 for the region. For example, the reserve module 106 may receive risk factors for a region from the risk module 120, which are determined by the current status of one or a plurality of property owners 144 that have properties in the region and currently have a residential net lease. In some embodiments, the risk factors may include fixed and variable costs of the property, cost of utility bills of the property, property tax of the property, insurance costs of the property, etc., to determine the risk factors of the region, such as high fix costs, increase in costs of utility bills, increase in property taxes and insurance, the starting market rent, the market growth rate, the inflation rate, the vacancy rate, the rent collectability rate, the home price appreciation, the operating expenses, the local taxes, the insurance rates, the management fees, the maintenance budget, the home owners association fees, the cost of utilities, and the asset management fees.

If it is determined that there are risk factors for the region, the reserve module 106 receives, at step 306, the risk factors from the risk module 120. For example, the reserve module 106 receives the risk factors, which may be fixed and variable costs of the property, cost of utility bills of the property, property tax of the property, insurance costs of the property, etc., to determine the risk factors of the region, such as high fix costs, increase in costs of utility bills, increase in property taxes and insurance, the starting market rent, the market growth rate, the inflation rate, the vacancy rate, the rent collectability rate, the home price appreciation, the operating expenses, the local taxes, the insurance rates, the management fees, the maintenance budget, the home owners association fees, the cost of utilities, and the asset management fees. In some embodiments, the risk factors may include a plurality of data points that indicate that the estimates used to create the parameters need to be adjusted to enhance the algorithm used to create the parameters to identify properties that may be profitable by being offered a residential net lease.

If it is determined that there are no risk factors for the region or after the risk factors are received from the risk module 120, the reserve module 106 creates, at step 308, the parameters for the net lease for the region. For example, the reserve module 106 may use the data stored in the expenses database to create parameters for residential net leases to identify residential properties that would be profitable with a residential net lease. For example, if the reserve module 106 may calculate an average range that could be charged for rent depending on the cost per square foot, such as if renters in Boston, MA, typically pay $4.50 per square foot of a property and the average square footage of a studio apartment is 800 square feet to 1,000 square feet, the average rent for a studio apartment may be $3,600 to $4,500. In some embodiments, the calculations may incorporate the number of bedrooms and bathrooms to adjust the average rental price based on square footage. In some embodiments, the calculations may incorporate the area's average fixed and variable costs of properties. In some embodiments, the calculations may use the average rental price and average fixed and variable costs to determine the average profit of a rental property.

In some embodiments, the calculations may use a percentage of the average rental price to determine the average commitment to a property owner 144 to determine the profits, for example, if the average rent price was $3,600 a month and the owner 144 typically received an amount of 80% for a net lease agreement then the calculations would subtract the 80% for the net lease and the fixed and variable costs to determine the average monthly profit of a residential rental property. For example, if risk factors were received from the risk module 120, the reserve module 106 may adjust the algorithm used to create the parameters to improve the algorithm. For example, if the rentability of the properties in the region is a risk factor the reserve module 106 may decrease the rent estimates by 10% to improve the estimates for average rent for the area. If the risk factors are the fixed and variable costs, the reserve module 106 may increase the estimated fixed and variable costs in the region by 10% to improve the algorithm's estimates.

In some embodiments, the percentage increase or decrease may be a predetermined increase or decrease by the amount of property owners 144 with a negative current status in the area. For example, if there are 20% of property owners 144 with a negative status in the area, the increase or decrease may be 5%. If 40% of property owners 144 with a negative status in the area, then the increase or decrease may be 10%. If 60% of property owners 144 with a negative status in the area, the increase or decrease may be 15%, etc.

The reserve module 106 stores, at step 310, the parameters in the parameters database 134. For example, the reserve module 106 may store all the data from the calculating the parameters in the parameters database 134, such as the location or region, the square foot range of the property, the number of bedrooms, the number of bathrooms, the rent range that could be charged for the property, the average range of fixed and variable costs for the property, and the potential profit range of the property. An example parameters database is provided below.

| Location | Square Footage Range | Bedrooms | Bathrooms | Rent Range | Fixed Cost Range | Potential Profit Range |
|---|---|---|---|---|---|---|
| Boston, MA | 600-800 | Studio | 1 | $1,600-$2,000 | $80-$120 | $300-$500 |
| Boston, MA | 800-1,000 | 1 | 1 | $1,800-$2,200 | $100-$130 | $400-$600 |
| Boston, MA | 1,000-1,200 | 2 | 1 | $2,200-$2,700 | $110-$150 | $500-$600 |
| — | — | — | — | — | — | — |
| — | — | — | — | — | — | — |
| — | — | — | — | — | — | — |

The example parameters database contains the parameters created during the process described in the reserve module 106 used to determine if a potential property would be profitable for a residential net lease from the net lease network 102. The database contains the location or region, the square foot range of the property, the number of bedrooms, the number of bathrooms, the rent range that could be charged for the property, the average range of fixed and variable costs for the property, and the potential profit range of the property. In some embodiments, the database may contain a plurality of locations based on the region of the country, the state the property resides in, the city where the property is located, the town or section of a city the property is located, etc. In some embodiments, the parameters may be determined by the property's square footage, the number of bedrooms the property has, the rent that may be charged for the residential property, or a combination of the parameters.

The reserve module 106 determines, at step 312, if there are any more regions remaining in the expenses database 128. For example, if there are more regions, cities, towns, etc., in the expenses database 128, then the reserve module 106 extracts the next region, and the process returns to determine the region's parameters. If it is determined that more regions are remaining in the expenses database 128, the reserve module 106 extracts, at step 314, the next region from the expenses database 128, and the process returns to creating the parameters for the net lease for the region. If it is determined that there are no more regions remaining in the expenses database 128, the reserve module 106 returns, at step 316, to the net lease module 104.

An example expenses database is provided below.

| | Starting | | | | | Home | |
|---|---|---|---|---|---|---|---|
| | Market | Growth | | Vacancy | Rent | Price | Operating |
| Location | Rent | Rate | Inflation | Rate | Collectability | Appreciation | Expenses |
| Boston, MA | $4.60/sq. ft. | 5% | 7.70% | 0.47% | 95% | 8.11% | BostonOE.Data |
| New York, NY | $9.00/sq. ft. | 10% | 7.70% | 1.20% | 92% | 12% | NewYorkOE.Data |
| Los Angeles, CA | $7.00/sq. ft. | 8% | 7.70% | 3% | 91% | 10% | LosAngeles.Data |
| — | — | — | — | — | — | — | — |
| — | — | — | — | — | — | — | — |

The example expenses database may contain the location of where the market data is for, the starting market rent, the market growth rate, the inflation rate, the vacancy rate, the rent collectability rate, the home price appreciation, and the operating expenses, which are stored as a data file and may contain the local taxes, the insurance rates, the management fees, the maintenance budget, the homeowners association fees, the cost of utilities, and the asset management fees. In some embodiments, the market data may be for a specific location or region or may be specific to a certain property location.

In some embodiments, each of the data points stored in the database may be used as an input into an algorithm to determine the net lease terms for the property owner 144, determine the rent for the specific property, and determine the profits or return on investment for the investors 146. In some embodiments, the starting market price may be the cost per square footage, the average cost of rent in a certain location, the average cost of rent in a certain location based on the number of bedrooms, the average cost of rent in a certain region of a city or town, etc. In some embodiments, the net lease module 104 may send a request to the expenses network 152 to receive relevant data points for a specific property location, for example, by using the mailing address.

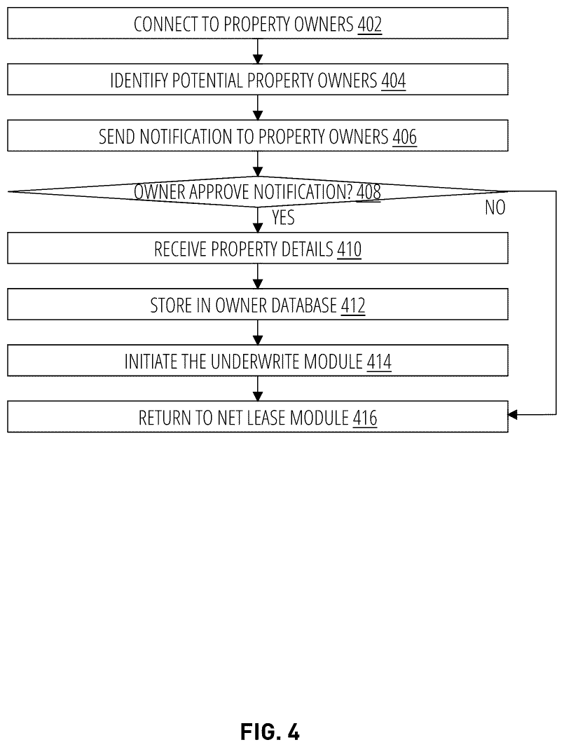

FIG. 4 displays an example method performed by the owner module 108. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the owner module 108 being initiated by the net lease module 104. In some embodiments, the owner module 108 may not need to be initiated and is continuously running in the background of the net lease network 102. The owner module 108 connects, at step 402, to the property owners 144. For example, the owner module 108 connects to the property owners 144 through the cloud 154, owners 144 may log in to the net lease network 102, sign up to the net lease network 102, etc. In some embodiments, the owner module 108 may find potential property owners 144 through rental listings, apartment listings, etc., and offer the property owner 144 the net lease terms once they are created. In some embodiments, the property owner 144 may be required to input their information, such as name, location of the residential rental property, e-mail address, etc., to receive the net lease terms from the owner module 108.

The owner module 108 identifies, at step 404, the potential property owners that may have a property that is within the parameters for a net lease. For example, the owner module 108 may identify residential properties that would be candidates for residential net leases by comparing the readily available data on the properties to the parameters stored in the parameters database 134. For example, the owner 144 may send data to the owner module 108, such as square footage, number of bedrooms, number of bathrooms, current rent, etc., and the owner module 108 compares the received data to the parameters database 134 to determine if the received data falls within the parameters. In some embodiments, the owner module 108 may use third-party sources to extract the data on the residential properties to determine if the property falls within the range of the parameters stored in the parameters database 134.

The owner module 108 sends, at step 406, a notification to the property owners 144 that have a property that fulfills the parameters for a net lease. For example, if the residential property data is within the parameters of the parameters database 134, then the owner module 108 may send a notification, such as an e-mail, automated phone call, notification through the net lease network 102, etc., to the owner. In some embodiments, the owner module 108 may send the owner an estimate of a potential net lease agreement. The owner module 108 determines, at decision block 408, if the owner approves the notification. For example, the owner module 108 determines if the owner 144 responds to the notification either by e-mail, logging onto the net lease network 102, etc.

If the owner approves the notification, the owner module 108 receives, at step 410, the property details from the property owner 144. For example, the owner 144 sends the owner module the data related to the residential property, such as the square footage, number of bedrooms, number of bathrooms, current condition of the property, the current condition of the appliances, current rent, the current property management group, etc. The owner module 108 stores, at step 412, the data in the owners database 132. For example, the owner module 108 stores the received data in the owners database 132, such as the owner's name, the owner ID, the property ID, the property address, the square footage, the number of bedrooms, and the number of bathrooms, average utility bills, property tax, insurance costs, condition of the property, condition of current appliances, current rates they charge for rent, if the property is vacant or if it currently has renters, the application process the owner uses for renters, etc.

The owner module 108 initiates, at step 414, the underwrite module 110. For example, the underwrite module 110 begins by being initiated by the owner module 108. The underwrite module 110 extracts the property owner 144 data from the owners database 132. The underwrite module 110 connects to the 3rd party financial expert network 156. The underwrite module 110 sends the extracted property owner 144 data from the owners database 132 to the 3rd party financial expert network 156. The underwrite module 110 receives the property owner 144 data from the 3rd party financial expert network 156. The underwrite module 110 stores the received property owner 144 data from the 3rd party financial expert network 156 in the approval database 136. The underwrite module 110 initiates the diligence module 112. if it is determined that the owner did not approve of the notification or after the data is stored in the owners database 132, the owner module 108 returns, at step 416, to the net lease module 104.

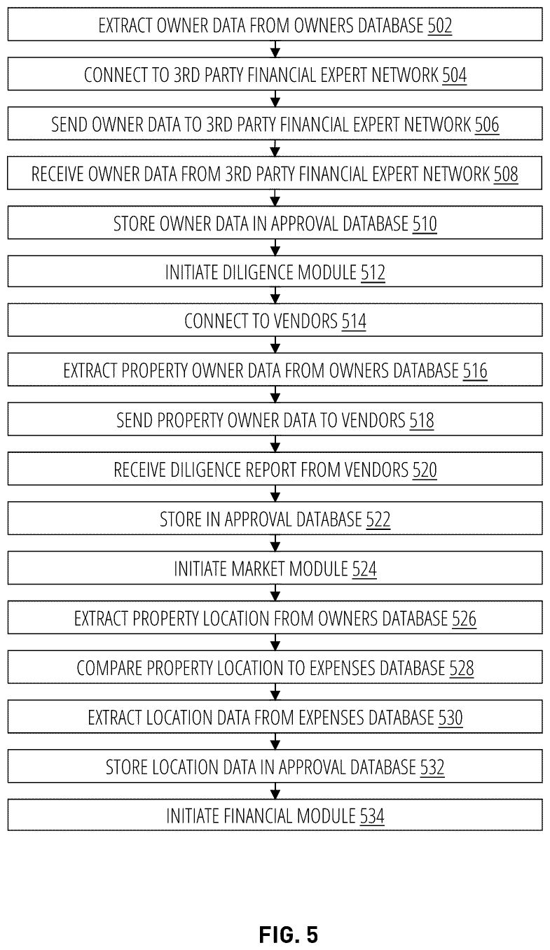

FIG. 5 displays an example method performed by an underwrite module, a diligence module, and a market module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the underwrite module 110 being initiated by the owner module 108 or the net lease module 104. For example, the owner module 108 initiates the underwrite module 110 once a new property owner 144 is stored in the owners database 132 to determine if the property owner 144 would be approved for a residential net lease. For example, the net lease module 104 may initiate the underwrite module 110 periodically at a predetermined time period, such as weekly, monthly, quarterly, yearly, etc., to continuously review the property owner's 144 current status. In some embodiments, the underwrite module 110 may be continuously querying the owners database 132 for a new entry, and once a new entry is added, the underwrite module 110 extracts the data to begin the process.

The underwrite module 110 extracts, at step 502, the property owner 144 data from the owners database 132. For example, the underwrite module 110 extracts the property owner 144 data from the owners database 132, such as the property owner's 142 name, ID, address, etc. The underwrite module 110 connects, at step 504, to the 3rd party financial expert network 156. For example, the underwrite module 110 connects to the 3rd party financial expert network 156 through the cloud 154. The 3rd party financial expert 156 may be a company, service, or individual that performs the underwriting process of investigating a property owner's 142 credit history, verifying their income to debt ratio, verifying their employment, verifying their income, ordering or performing an appraisal to determine the value of the home, etc. In some embodiments, the 3rd party financial expert 156 may receive the property owner's 142 data from the underwrite module 110 and then proceed to collect the information about the property owner 144 and send the collected information back to the underwrite module 110.

The underwrite module 110 sends, at step 506, the extracted property owner 144 data from the owners database 132 to the 3rd party financial expert network 156. For example, the underwrite module 110 sends the property owner 144 data, such as the property owner's 142 name, ID, address, etc., to the 3rd party financial expert network 156. The underwrite module 110 receives, at step 508, the property owner 144 data from the 3rd party financial expert network 156. For example, the underwrite module 110 receives data about the property owner 144 from the 3rd party financial expert network 156, such as the property owner's 142 credit score, debt-to-income ratio, employment verification, income verification, etc.

In some embodiments, the underwriting data may include an appraisal from a 3rd party, the amount of money in a savings account or a plurality of savings accounts, and the 3rd party financial expert network 156 that was used for the underwriting process. The underwrite module 110 stores, at step 510, the received property owner 144 data from the 3rd party financial expert network 156 in the approval database 136. For example, the underwrite module 110 stores the received data from the 3rd party financial expert network 156 in the approval database 136, such as the property owner's 142 credit score, debt to income ratio, employment verification, income verification, etc. In some embodiments, the underwriting data may include an appraisal from a 3rd party, the amount of money in a savings account or a plurality of savings accounts, and the 3rd party financial expert network 156 that was used for the underwriting process.

The underwrite module 110 may employs natural language processing (NLP) techniques to analyze the rental history of potential property owners, identifying patterns, anomalies, and trends within the data, providing insights into credit risk. b. Machine learning models are integrated with the NLP algorithms to assess key factors such as payment history, credit utilization, and debt-to-income ratios, using advanced algorithms like linear regression, logistic regression, and support vector machines (SVM). The analysis may ensure accurate credit risk assessment for potential property owners.

The underwrite module 110 may employ advanced decision trees to evaluate the creditworthiness of potential property owners based on their credit history, income, employment status, and debt obligations. The decision trees use novel algorithmic structures, such as random forests and gradient boosting machines (GBM), to optimize the assessment process by identifying patterns and relationships between variables.

To enhance investment decisions, the underwrite module 110 may also employ sentiment analysis techniques to analyze online reviews and ratings of properties. The sentiment analysis uses deep learning architectures like Recurrent Neural Networks (RNN) and Convolutional Neural Networks (CNN) to identify areas with high demand and positive sentiment. e. To ensure efficient data processing, the underwriting module is equipped with GPU-accelerated servers that can handle large volumes of data and adjust to changing market conditions in real time. This ensures consistent and reliable decision-making across a broad range of property rental scenarios.

The underwrite module 110 may also incorporates feedback mechanisms that continuously learn from past decisions, improving the accuracy and precision of future assessments using reinforcement learning algorithms like Q-learning and Deep Q Networks (DQN). g. To maintain the privacy and security of user data, the underwriting module employs end-to-end encryption techniques and follows industry best practices for data protection and compliance, such as GDPR and CCPA. The underwrite module 110 may integrated with existing property rental platforms or real estate management systems using modern APIs like RESTful APIs and GraphQL.

The underwrite module 110 initiates, at step 512, the diligence module 112. In some embodiments, the diligence module 112 may be initiated once a new property owner 144 is stored in the owners database 132 to determine if the property owner 144 would be approved for a residential net lease. In some embodiments, the diligence module 112 may be continuously querying the owners database 132 for a new entry, and once a new entry is added, the diligence module 112 extracts the data to begin the process.

The diligence module 112 connects, at step 514, to the vendors 148. For example, the diligence module 112 connects to the vendors 148 to locate and assign a property manager 142 to perform the due diligence on the property, such as an appraisal, site visit, inspection, etc. The diligence module 112 extracts, at step 616, the property owner 144 data from the owners database 132. For example, the diligence module 112 extracts the property owner 144 data from the owners database 132, such as the owner's name, the owner ID, the property ID, the property address, the square footage, the number of bedrooms, the number of bathrooms, etc. The diligence module 112 sends, at step 518, the property owner 144 data to the vendor 148. For example, the diligence module 112 sends the property owner 144 data such as the owner's name, the owner ID, the property ID, the property address, the square footage, the number of bedrooms, bathrooms, etc., to the vendor 148. In some embodiments, the diligence module 112 may send the property owner's 142 data to the property manager 142 that has been assigned to perform the due diligence on the property. In some embodiments, the property manager 142 may be selected on the property manager's 140 location in relation to the property to assess the property of the property owner 144.

The diligence module 112 receives, at step 520, the diligence report from the vendor 148. For example, the diligence module 112 receives a due diligence report from the vendor 148 or the property manager 142, which may include repair estimates, property insurance, a value projection, a location assessment, parking at the property, a physical inspection performed by a property manager 142, the homeowner's association rules, an appraisal, an examination of the title of the property, etc. The diligence module 112 stores, at step 522, the diligence report from the vendor 148 in the approval database 136. For example, the diligence module 112 stores the received data from the vendor 148 or the property manager 142 in the approval database 136, such as the repair estimates, property insurance, a value projection, a location assessment, parking at the property, a physical inspection performed by a property manager 142, the homeowner's association rules, an appraisal, an examination of the title of the property, etc.

The diligence module 112 may incorporate object detection algorithms and convolutional neural networks (CNN) to analyze property images, accurately identifying signs of wear and tear, needed repairs, and potential security risks. To improve the accuracy of the analysis, the diligence module 112 may use transfer learning techniques, leveraging pre-trained models that have been trained on large datasets of property images, to quickly adapt to new properties. The diligence module 112 may generate a comprehensive risk report for the property owner, outlining areas requiring immediate attention, potential repair costs, and recommendations for addressing security risks. The diligence module 112 may employ machine learning algorithms that continuously learn from past inspections, improving the accuracy of future assessments.

In addition to property inspection, the diligence module 112 can also be used for virtual walkthroughs, allowing property managers and owners to review properties remotely without physically visiting the site. This can help save time and resources while providing an accurate assessment of a property's condition. By automating the property inspection process, the diligence module 112 can help reduce human error and bias, providing an objective and data-driven assessment of a property's condition, to help property managers and owners make informed decisions about repairs, maintenance, and investments in their properties.

The diligence module 112 may initiates, at step 524, the market module 114. In some embodiments, the market module 114 may be initiated once a new property owner 144 is stored in the owners database 132 to determine if the property owner 144 would be approved for a residential net lease. In some embodiments, the market module 114 may be continuously querying the owners database 132 for a new entry, and once a new entry is added, the market module 114 extracts the data to begin the process.

The market module 114 extracts, at step 526, the property location from the owners database 132. For example, the market module 114 may extract the location or address of the property owner's 142 property from the owners database 132. The market module 114 compares, at step 528, the extracted property location from the owners database 132 to the expenses database 128. For example, the market module 114 may compare the extracted location of the property owner's 142 property to the expenses database 128 to extract the market data from the expenses database 128 related to the property owner's 142 property.

The market module 114 extracts, at step 530, the location data from the expenses database 128. For example, the market module 114 extracts the market data related to the region, state, city, or town where the property owner's 142 property resides. For example, the extracted data may be the starting market rent per square foot, the growth rate, the inflation rate, the vacancy rate, the rent collectability rate, etc. The market module 114 stores, at step 532, the location data in the approval database 136. For example, the market module 114 stores the extracted location data from the expenses database 128 in the approval database 136, such as the starting market rent per square foot, the growth rate, the inflation rate, the vacancy rate, the rent collectability rate, etc.

The market module 114 may collect comprehensive data on local real estate markets, including rental rates, vacancy rates, and sales prices, via various sources such as public records, real estate listings, and market reports. The market module 114 may then using machine learning algorithms to analyze the collected data, which identify patterns and trends within the data to provide insights into market conditions. By analyzing market trends, the market module 114 can pinpoint areas with high demand and limited supply, indicating potential opportunities for investment. To further refine investment decisions, the market module 114 may employ machine learning algorithms to analyze online reviews and ratings of properties in target areas. This data is used to gauge market sentiment and identify areas with positive sentiment. Based on the insights gathered from both quantitative and qualitative data analysis, the market module 114 generates optimized pricing strategies for properties in high-demand areas. The pricing strategy takes into account various factors such as local market trends, property characteristics, and competitor pricing to ensure competitive and profitable listings.

The market module 114 may further integrate with the underwrite module 110 by performing a detailed analysis of each property's financial viability based on factors such as cash flow, debt service coverage ratio (DSCR), and loan-to-value (LTV) ratios. The underwrite module 110 may further use machine learning algorithms to assess the risk associated with each investment opportunity, taking into account factors such as property location, market conditions, and borrower creditworthiness. The market module 114 initiates, at step 534, the financial module 116.

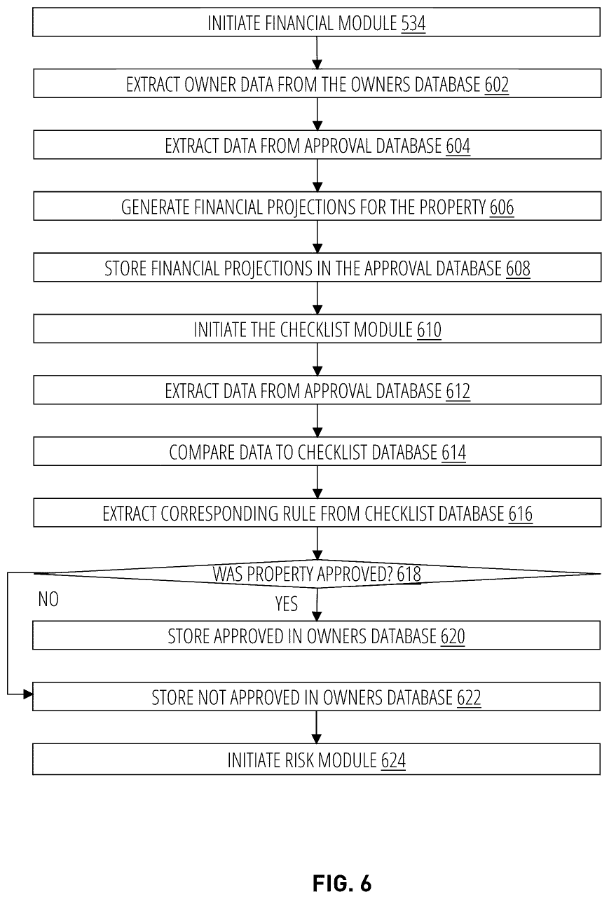

FIG. 6 displays an example method performed by the financial module and the checklist module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process may begin with the financial module 116 being initiated, at step 534, by the market module 114. In some embodiments, the financial module 116 may be initiated once a new property owner 144 is stored in the owners database 132 to determine if the property owner 144 would be approved for a residential net lease. In some embodiments, the financial module 116 may be continuously querying the owners database 132 for a new entry, and once a new entry is added, the financial module 116 extracts the data to begin the process. The financial module 116 extracts, at step 602, the property owner 144 data from the owners database 132. For example, the financial module 116 extracts the property owner 144 data such as the owner's name, the owner ID, the property ID, the property address, the square footage, the number of bedrooms, the number of bathrooms, average utility bills, property tax, insurance costs, condition of the property, condition of current appliances, etc. In some embodiments, the owner may send the net lease network 102 the current rates they charge for rent, if the property is vacant or if it currently has renters, the application process the owner uses for renters, etc.

The financial module 116 extracts, at step 604, the data from the approval database 136. For example, the financial module 116 extracts the data stored in the approval database 136, such as underwriting, due diligence, and market data. For example, the financial module 116 extracts the data such as the property owner's 142 credit score, debt to income ratio, employment verification, income verification, repair estimates, property insurance, the starting market rent per square foot, the growth rate, the inflation rate, the vacancy rate, the rent collectability rate, an appraisal from a 3rd party, amount of money in a savings account or a plurality of savings accounts, the 3rd party financial expert network 156 that was used for the underwriting process, a value projection, a location assessment, parking at the property, a physical inspection performed by a property manager 142, the homeowner's association rules, an appraisal, an examination of the title of the property, the local taxes, the insurance rates, the management fees, the maintenance budget, the homeowner's association fees, the cost of utilities, the asset management fees, etc.

The financial module 116 generates, at step 606, the financial projections for the property. For example, the financial module 116 may use the extracted data from the owners database 132 and the approval database 136 as inputs into a machine-learning algorithm that outputs a range of estimates of financial projections of a residential net lease for the property, such as a range for lease commitments to the property owner 144, a range for a yearly lease commitment increase, a range of fixed and variable costs, a range of rent that may be charged for the property, and a range of potential monthly profits, etc. For example, if the residential rental property is located in Boston, MA, then the starting market rent, the market growth rate, the inflation rate, the vacancy rate, the rent collectability rate, the home price appreciation, the operating expenses such as the local taxes, the insurance rates, the management fees, the maintenance budget, the homeowners association fees, the cost of utilities, and the asset management fees would be used as inputs into the algorithm to determine the financial projections.

For example, the algorithm may use the average rent per square footage. The square footage of the property owners 144 residential property to determine a range of the cost of rent for the property, such as the average rent per square foot is $4.50 in Boston, MA, and the property owners 144 property is 800 square feet, resulting in a rent price of $3,600 per month, which could then could be increased and decreased by a certain percentage, such as 10%, to create an estimated rent of $3,240 to $3,960. The other inputs, such as the market growth rate, the inflation rate, the vacancy rate, the rent collectability rate, the home price appreciation, the operating expenses, etc., may be used in the algorithm as weighted averages or percentages to increase or decrease the rental price of the property. The algorithm may determine an estimate of net lease terms for the property owner 144 on a percentage of the possible rent that the net lease network 102 could charge tenants, such as 75% or between $2,430 to $2,970 per month. In some embodiments, the financial module 116 may determine a range for lease commitments to the property owner 144, a range for a yearly lease commitment increase, a range of fixed and variable costs, a range of rent that may be charged for the property, and a range of potential monthly profits, etc. to create the financial projections.

The financial module 116 stores, at step 608, the financial projections in the approval database 136. For example, the financial module 116 stores the financial projections, such as a range for lease commitments to the property owner 144, a range for a yearly lease commitment increase, a range of fixed and variable costs, a range of rent that may be charged for the property, and a range of potential monthly profits, etc. in the approval database 136. In some embodiments, the financial projections may be stored as a data file in the approval database 136. The financial module 116 initiates, at step 610, the checklist module 118.

In some cases, the financial module 116 may utilize APIs or database queries to gather data from various sources, such as the owners database 132 and the approval database 136. The financial module 116 may further implement data cleaning and preprocessing steps, like handling missing values, removing outliers, and normalizing numerical data. The financial module 116 may store the extracted data in a structured format suitable for further analysis, such as CSV or JSON files.

The financial module 116 may encode categorical variables using techniques like one-hot encoding, ordinal encoding, or label encoding. The financial module 116 may further create new features by combining existing ones, such as computing the ratio of living area to price or calculating the age of a property. The financial module 116 may apply dimensionality reduction techniques like Principal Component Analysis (PCA) or t-Distributed Stochastic Neighbor Embedding (t-SNE) for easier visualization and model training. The financial module 116 may further research various machine learning algorithms suitable for the problem at hand, such as Linear Regression, Decision Trees, Random Forests, or Neural networks. The financial module 116 may compare the performance of different models using metrics like Mean Absolute Error (MAE), Root Mean Squared Error (RMSE), or R² to choose the best model for the task.

For training, the financial module 116 may split the data into training, validation, and test sets to ensure that the model generalizes well to unseen data. The financial module 116 may train the chosen machine learning model using a suitable optimization algorithm like Stochastic Gradient Descent (SGD) or Adam to minimize the error between predicted and actual values. The financial module 116 may further evaluate the model's performance using validation data and select appropriate metrics like MAE, RMSE, or R² for comparison with other models. The financial module 116 may further tune hyperparameters, such as learning rate, regularization strength, or tree depth, to optimize the model's performance on validation data.

The financial module 116 may further apply the trained machine learning model to new input data, such as a property's characteristics and market conditions, to generate financial projections. The financial module 116 may further implement techniques like SHAP (SHapley Additive exPlanations) or LIME (Local Interpretable Model-agnostic Explanations) to provide insights into why the model made a particular prediction. The financial module 116 may visualize the importance of each feature in the model's predictions, helping users understand which factors most impact financial projections. The financial module 116 may periodically retrain the model with new data and feedback from users to improve its performance over time, and implement techniques like transfer learning or active learning to adapt the model more quickly to changes in market conditions and user preferences.

The financial module 116 may incorporate reinforcement learning techniques for dynamic rental pricing strategies, allowing the financial module 116 to learn from real-world interactions with tenants and adjust its pricing strategy accordingly. The financial module 116 may use deep learning networks to optimize rent prices over time, maximizing profits while minimizing tenant churn.

In some embodiments, the checklist module 118 may be initiated once the underwriting data, due diligence data, market, and financial projections are stored in the approval database 136. The checklist module 118 extracts, at step 612, the data from the approval database 136. For example, the checklist module 118 extracts the data from the approval database 136, such as the property owner's 142 ID, the property ID, the underwriting data, such as the property owner's 142 credit score, debt to income ratio, employment verification, income verification, repair estimates, property insurance, the starting market rent per square foot, the growth rate, the inflation rate, the vacancy rate, the rent collectability rate, a range for lease commitments to the property owner 144, a range for a yearly lease commitment increase, a range of fixed and variable costs, a range of rent that may be charged for the property, and a range of potential monthly profits, etc.

In some embodiments, the extracted data may be the property owner's 142 address, job title, employer, number of properties owned, the property address, the square footage, the number of bedrooms, the number of bathrooms, average utility bills, property tax, insurance costs, condition of the property, condition of current appliances, the current rates they charge for rent, if the property is vacant or if it currently has renters, the application under process the owner uses for renters, an appraisal from a 3rd party, amount of money in savings account or plurality of savings accounts, the 3rd party financial expert network 156 that was used for the underwriting process, a value projection, a location assessment, parking at the property, a physical inspection performed by a property manager 142, the homeowner's association rules, an appraisal, an examination of the title of the property, the local taxes, the insurance rates, the management fees, the maintenance budget, the homeowner's association fees, the cost of utilities, the asset management fees, an estimate of the total investment required for the property, potential returns on the investment for individual investors, year to year return on investment, etc.

The checklist module 118 compares, at step 614, the data from the approval database 136 to the checklist database 138. For example, the data stored in the approval database 136 is compared to the checklist database 138, such as the property owner's 142 credit score is extracted and compared to the checklist database 138 in which if the property owner's 142 credit score is above 650 then the rule would be to check the next requirement which would be if the property owner's 142 debt to income ratio is below 35%. If the property owner's 142 credit score is below 650, then the corresponding rule would be to not approve of the property owner 144 for a residential net lease and would be stored in the owners database 132. In some embodiments, the requirements may be predetermined thresholds set by an administrator of the net lease network 102. In some embodiments, the property owner may be required to meet all of the requirements of the checklist database 138 to be offered a residential net lease. In some embodiments, the property owner 144 may be required to meet a certain percentage of the requirements in the checklist database 138 to be offered a residential net lease, such as 90% of the requirements, 80% of the requirements, 70% of the requirements, etc. In some embodiments, the requirements may be associated with a weighted scoring system, and the property owner 144 would be required to meet a certain score to be offered a residential net lease.

For example, each requirement would be given a weighted score, such as having a good credit score and debt-to-income ratio would result in a higher score than the number of bathrooms in a property or the number of parking spots. The property owner's 142 data stored in the approval database 136 would be compared to the checklist database 138 to determine the property owner's 142 score, and if above a predetermined threshold, the property owner 144 would be offered a residential net lease. The checklist module 118 extracts, at step 616, the corresponding rule from the checklist database 138. For example, if the property owner's 142 credit score is below 650, then the corresponding rule would be to not approve the property owner 144 for a residential net lease and would be stored in the owners database 132. If the property owner's 142 credit score is above 650, then the rule would be to check the next requirement: if the property owner's 142 debt-to-income ratio is below 35%.

The checklist module 118 determines, at decision block 618, if the property was approved for a residential net lease. For example, the checklist module 118 compares the data from the approval database 136 to the checklist database 138, and if the property owner 144 meets all of the requirements of the checklist database 138, the extracted rule would be that the property owner 144 is approved for a residential net lease. However, if the property owner 144 does not meet all of the requirements of the checklist database 138 or a predetermined percentage of the requirements of the checklist database 138, the extracted rule would be that the property owner 144 would not be approved for a residential net lease. If it is determined that the property was approved for a residential net lease, the checklist module 118 stores, at step 620, that the property is approved in the owners database 132. For example, the checklist module 118 compares the data from the approval database 136 to the checklist database 138, and if the property owner 144 meets all of the requirements of the checklist database 138, the extracted rule would be that the property owner 144 is approved for a residential net lease, and the approval status would be stored in the owners database 132.

If it is determined that the property was not approved for a residential net lease, the checklist module 118 stores, at step 622, that the property was not approved in the owners database 132. For example, if the property owner 144 does not meet all of the requirements of the checklist database 138 or a predetermined percentage of the requirements of the checklist database 138, the extracted rule would be that the property owner 144 would not be approved for a residential net lease and the approval status would be stored in the owners database 132 The checklist module 118 initiates, at step 624, the risk module 120. For example, the risk module 120 begins by being initiated by the checklist module 118. The risk module 120 filters the owners database 132 on the approved property owners 144. The risk module 120 extracts the first approved property owner 144 from the owners database 132. The risk module 120 filters the approval database 136 and the lease database 130 on the approved property owner 144.

An example checklist database is provided below.

| # | Requirement | Rule |
|---|---|---|
| 1 | Credit Score Above 650 | If yes, Check Next Requirement |
| | | If No, Not Approved |
| 2 | Debt to Income Ratio Below 35% | If yes, Check Next Requirement |
| | | If No, Not Approved |
| 3 | Employment Verified | If yes, Check Next Requirement |
| | | If No, Not Approved |
| 4 | Income Verified | If yes, Check Next Requirement |
| | | If No, Not Approved |
| — | — | — |
| — | — | — |
| — | — | — |

The example checklist database contains the requirements for the property owner's 142 property or properties to be approved to be offered a residential net lease from the net lease network 102. The database contains a series of requirements and a corresponding rule if the requirement is met or not. For example, the data stored in the approval database 136 is compared to the checklist database 138, such as the property owner's 142 credit score is extracted and compared to the checklist database 138 in which if the property owner's 142 credit score is above 650 then the rule would be to check the next requirement which would be if the property owner's 142 debt to income ratio is below 35%. If the property owner's 142 credit score is below 650, then the corresponding rule would be to not approve of the property owner 144 for a residential net lease and would be stored in the owners database 132. In some embodiments, the requirements may be predetermined thresholds set by an administrator of the net lease network 102.

In some embodiments, the requirements may include rules for the property owner's 142 credit score, debt to income ratio, employment verification, income verification, repair estimates, property insurance, the starting market rent per square foot, the growth rate, the inflation rate, the vacancy rate, the rent collectability rate, a range for lease payments to the property owner 144, a range for a yearly lease payment increase, a range of fixed and variable costs, a range of rent that may be charged for the property, and a range of potential monthly profits, the square footage, the number of bedrooms, the number of bathrooms, average utility bills, property tax, insurance costs, condition of the property, condition of current appliances, the current rates they charge for rent, if the property is vacant or if it currently has renters, the application process the owner uses for renters, amount of money in savings account or plurality of savings accounts, a value projection, a location assessment, parking at the property, a physical inspection performed by a property manager 142, the homeowner's association rules, an appraisal, an examination of the title of the property, the local taxes, the insurance rates, the management fees, the maintenance budget, the homeowner's association fees, the cost of utilities, the asset management fees, etc.

In some embodiments, the property owner may be required to meet all of the requirements of the checklist database 138 to be offered a residential net lease. In some embodiments, the property owner 144 may be required to meet a certain percentage of the requirements in the checklist database 138 to be offered a residential net lease, such as 90% of the requirements, 80% of the requirements, 70% of the requirements, etc. In some embodiments, the requirements may be associated with a weighted scoring system, and the property owner 144 would be required to meet a certain score to be offered a residential net lease. For example, each requirement would be given a weighted score, such as having a good credit score and debt-to-income ratio would result in a higher score than the number of bathrooms in a property or the number of parking spots. The property owner's 142 data stored in the approval database 136 would be compared to the checklist database 138 to determine the property owner's 142 score, and if above a predetermined threshold, the property owner 144 would be offered a residential net lease.

The risk module 120 extracts the data from the approval database 136 and the lease database 130. The risk module 120 determines the property owner's 144 current status. The risk module 120 stores the property owner's 144 current status in the owners database 132. The risk module 120 determines if the property owner's 144 current status is negative. If it is determined that the property owner's 144 current status is negative, the risk module 120 determines the risk factors for the property's region. The risk module 120 sends the risk factors for the region to the reserve module 106. If it is determined that the property owner's 144 current status is not negative or after the risk module 120 sends the risk factors for the region to the reserve module 106, the risk module 120 determines if there are more approved property owners 144 in the owners database 132. If it is determined that there are more approved property owners 144 stored in the owners database 132, the risk module 120 extracts the next approved property owner 144, and the process returns to filtering the approval database 136 and the lease database 130. If it is determined that there are no more approved property owners 144 remaining in the owners database 132, the risk module 120 returns to the net lease module 104.

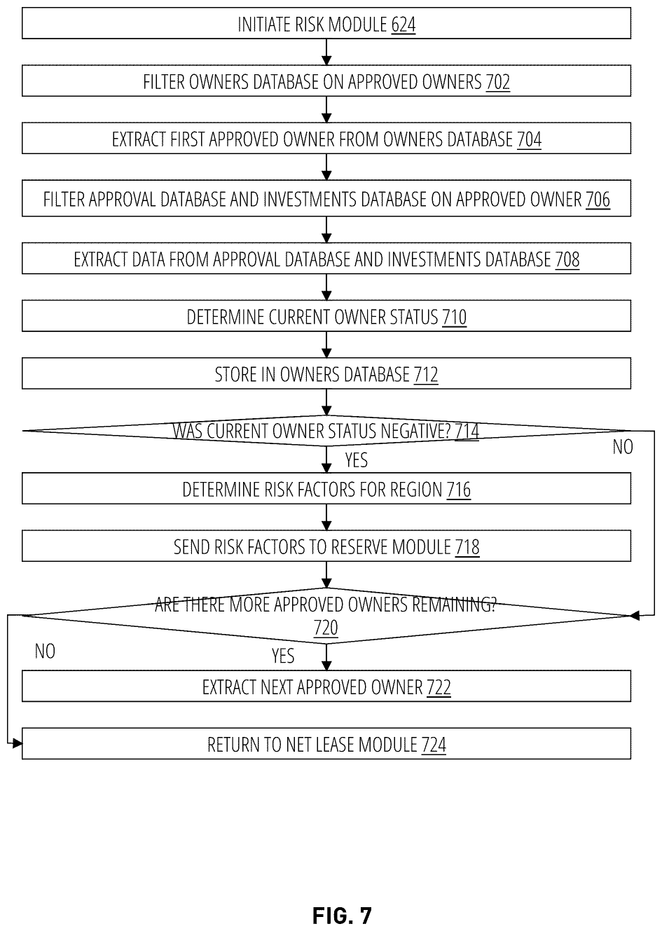

FIG. 7 displays an example method performed by the risk module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the risk module 120 being initiated, at step 624, by the checklist module 118. In some embodiments, the risk module 120 may be initiated periodically at predetermined time periods, such as weekly, monthly, quarterly, yearly, etc. The risk module 120 filters, at step 702, the owners database 132 on the approved property owners 144. For example, the risk module 120 filters the owners database 132 on property owners' 144 approved residential net leases. In some embodiments, the approved property owner's 144 may currently have a residential net lease with the net lease network 102.

The risk module 120 extracts, at step 704, the first approved property owner 144 from the owners database 132. For example, the risk module 120 extracts the property owner's 144 name, the property owner's 144 ID, the property ID, the property address, etc. In some embodiments, the risk module 120 may extract data related to the properties, such as the square footage, the number of bedrooms, the number of bathrooms, average utility bills, property tax, insurance costs, condition of the property, condition of current appliances, the current rates they charge for rent, if the property is vacant or if it currently has renters, the application process the owner uses for renters, etc.

The risk module 120 filters at step 706, the approval database 136, and the lease database 130 on the approved property owner 144. For example, the risk module 120 filters the approval database 136 and the lease database 130 on the data entries for the extracted property owner 144 from the owners database 132. The risk module 120 extracts, at step 708, the data from the approval database 136 and the lease database 130. For example, the risk module 120 extracts the underwriting data, such as the property owner's 142 credit score, debt to income ratio, employment verification, income verification, etc. due diligence, data such as repair estimates, property insurance, etc. the market data, such as the starting market rent per square foot, the growth rate, the inflation rate, the vacancy rate, the rent collectability rate, etc. and the financial projections, such as a range for lease commitments to the property owner 144, a range for a yearly lease commitment increase, a range of fixed and variable costs, a range of rent that may be charged for the property, and a range of potential monthly profits, etc. from the approval database 136. For example, the risk module 120 extracts the length of the lease or the years remaining on the net lease, the lease commitment to the property owner 144, the annual increase of the net lease commitment to the property owner, the fixed and variable costs per month for the property, the rent collected per month for the property, and the monthly profits for the property from the lease database 130.

The risk module 120 determines, at step 710, the property owner's 144 current status. For example, the risk module 120 may compare the data stored in the approval database 136 and the data stored in the lease database 130 to determine the property owner's 144 current status. The property owner's 144 current status may be the status of the investment of the residential net lease, including the profitability of the property, the overall revenue generated by the property, the fixed and variable costs of the property compared to similar properties in the region, cost of utility bills of the property compared to similar properties in the region, property tax of the property compared to similar properties in the region, insurance costs of the property compared to similar properties in the region, condition of the property compared to similar properties in the region, condition of current appliances of the property compared to similar properties in the region, etc.

For example, the property owner's 144 current status may be positive if the property generates a profit equal to or above the estimated profit stored in the approval database 136. For example, if the property was estimated to generate a monthly profit of $100-$725 and is actually generating $400 per month, the property or property owner 144 would have a positive current status. For example, the property owner 144 may have a negative current status if the property is operating at a loss compared to the estimates stored in the approval database 136. For example, if the property was estimated to generate a monthly profit of $100-$725 and is actually operating at a loss of $100 per month, then the property or property owner 144 would have a negative status. In some embodiments, if the property owner 144 has a negative status, the risk module may compare the estimates for the fixed and variable costs of the property, cost of utility bills of the property, property tax of the property, insurance costs of the property, etc. to the actual fixed and variable costs of the property, cost of utility bills of the property, property tax of the property, insurance costs of the property, etc. to determine the risk factors of the region, such as high fix costs, increase in costs of utility bills, increase in property taxes and insurance, etc.

An example approval database is provided below.

| | | | Underwriting | | | |
|---|---|---|---|---|---|---|
| Owner | Owner | | Credit | Debt to | | |
| Name | ID | Property ID | Score | Income Ratio | Employment | Income |
| John Smith | JS123 | JS123-001 | 700 | 15% | Verified | Verified |
| — | — | — | — | — | — | — |
| — | — | — | — | — | — | — |
| — | — | — | — | — | — | — |

| | | | Due Diligence | | Market | | | | |
|---|---|---|---|---|---|---|---|---|---|
| Owner | Owner | | Repair | | Starting | Growth | | Vacancy | Rent |
| Name | ID | Property ID | Estimates | Insurance | Market Rent | Rate | Inflation | Rate | Collectability |
| John Smith | JS123 | JS123-001 | $250- | $1,600 | $4.60/sq. ft. | 5% | 7.70% | 0.47% | 95% |
| — | — | — | — | — | — | — | — | — | — |
| — | — | — | — | — | — | — | — | — | — |
| — | — | — | — | — | — | — | — | — | — |

| | | | Financial Projections | | | | | |
|---|---|---|---|---|---|---|---|---|
| | | | | | Lease | | | |
| Owner | Owner | | Lease | Lease | Payment | Fixed | | Monthly |
| Name | ID | Property ID | Length | Payment | Increase | Costs | Rent Charged | Profits |
| John Smith | JS123 | JS123-001 | 10-15 | $1,800- | 1%-3% | $75-$100 | $2,300-$2,600 | $100- |
| — | — | — | — | — | — | — | — | — |
| — | — | — | — | — | — | — | — | — |
| — | — | — | — | — | — | — | — | — |

The example approval database contains the data collected by the underwrite module 110, diligence module 112, market module 114, and financial module 116, which is used to determine if a property owner 144 or property is approved for a residential net lease. The database contains the property owner's 142 name, the property owner's 142 ID, the property ID, the underwriting data, such as the property owner's 142 credit score, debt to income ratio, employment verification, income verification, etc., the due diligence, data such as repair estimates, property insurance, etc. the market data, such as the starting market rent per square foot, the growth rate, the inflation rate, the vacancy rate, the rent collectability rate, etc. and the financial projections, such as a range for lease payments to the property owner 144, a range for a yearly lease payment increase, a range of fixed and variable costs, a range of rent that may be charged for the property, and a range of potential monthly profits, etc. In some embodiments, the property owner 144 data may include the property owner's 142 address, job title, employer, number of properties owned, etc. In some embodiments, the property data may include the property address, the square footage, the number of bedrooms, the number of bathrooms, average utility bills, property tax, insurance costs, condition of the property, condition of current appliances, the current rates they charge for rent, if the property is vacant or if it currently has renters, the application process the owner uses for renters, etc.

In some embodiments, the underwriting data may include an appraisal from a 3rd party, the amount of money in a savings account or a plurality of savings accounts, and the 3rd party financial expert network 156 that was used for the underwriting process. In some embodiments, the underwriting process may be performed on the renters 150 of the property. In some embodiments, the due diligence data may include a value projection, a location assessment, parking at the property, a physical inspection performed by a property manager 142, the homeowner's association rules, an appraisal, an examination of the title of the property, etc. In some embodiments, the market data may include the local taxes, insurance rates, management fees, the maintenance budget, the homeowner's association fees, the cost of utilities, asset management fees, etc. In some embodiments, the financial projections may be based on a monthly, quarterly, or yearly basis. In some embodiments, the financial projections may include an estimate of the total investment required for the property, potential returns on the investment for individual investors, year-to-year return on investment, etc.

The risk module 120 stores, at step 712, the property owner's 144 current status in the owners database 132. For example, the risk module 120 stores if the property owner's 144 property has a current status that is either positive or negative. The risk module 120 determines, at decision block 714, if the property owner's 144 current status is negative. If it is determined that the property owner's 144 current status is positive, the process continues to determine if more approved property owners 144 are stored in the owners database 132. For example, if the risk module 120 stores that the property owner's 144 property has a negative status, it can determine the current status is negative.

If it is determined that the property owner's 144 current status is negative, the risk module 120 determines, at step 716, the risk factors for the property's region. For example, if the property owner 144 has a negative status, the risk module may compare the estimates for the fixed and variable costs of the property, cost of utility bills of the property, property tax of the property, insurance costs of the property, etc., to the actual fixed and variable costs of the property, cost of utility bills of the property, property tax of the property, insurance costs of the property, etc. to determine the risk factors of the region, such as high fix costs, increase in costs of utility bills, increase in property taxes and insurance, etc.

The risk module 120 sends, at step 718, the risk factors for the region to the reserve module 106. For example, if the property is located in Boston, MA, the risk module 120 sends that the risk factor for the region of Boston, MA, may include higher than usual or higher than estimated property taxes which may lead to a decrease in potential profitability for properties in the area. In some embodiments, the risk factors may include fixed and variable costs of the property, cost of utility bills of the property, property tax of the property, insurance costs of the property, etc., to determine the risk factors of the region, such as high fix costs, increase in costs of utility bills, increase in property taxes and insurance, the starting market rent, the market growth rate, the inflation rate, the vacancy rate, the rent collectability rate, the home price appreciation, the operating expenses, the local taxes, the insurance rates, the management fees, the maintenance budget, the homeowners association fees, the cost of utilities, and the asset management fees.

If it is determined that the property owner's 144 current status is not negative or after the risk module 120 sends the risk factors for the region to the reserve module 106, the risk module 120 determines, at decision block 720, if there are more approved property owners 144 in the owners database 132. If it is determined that there are more approved property owners 144 stored in the owners database 132, the risk module 120 extracts, at step 722, the next approved property owner 144, and the process returns to filtering the approval database 136 and the lease database 130. If it is determined that there are no more approved property owners 144 remaining in the owners database 132, the risk module 120 returns, at step 724, to the net lease module 104.

In some cases, the method for automating a residential net lease management tool that update net lease terms to minimize an overall risk level based on the predicted risk probabilities for risk factors, includes receiving, over an expense network, market data associated with a specific region sent over a communication network at a net lease management server configured to communicate with at least one third-party application. In some cases, the method includes initiating, by a net lease module, a reserve module, and generating, by the reserve module, net lease parameters for the specific region based on a calculated profitability evaluation based on the market data received via the expense network, where the calculated profitability evaluation determines a threshold margin based on a percentage of an average rental rate and average fixed costs in the specific region.

In some cases, the method includes initiating, by the net lease module, an owner module, and identifying, by the owner module, properties that fall within the net lease parameters generated by the reserve module, initiating, by the net lease module, a manage module, determining, by the manage module, fixed costs and variable costs based on data associated with at least one of the identified properties and extracted data points from stored invoice data, generating, by the reserve module, a set of net lease terms associated with the at least one of the properties identified by the net lease module, based on first inputs including the fixed costs and variable costs determined the manage module, where first weights are assigned to each first input, receiving an approval from a property owner of the generated set of net lease terms.

In some cases, the method includes initiating, by the net lease module, a risk module, and inputting, in a first machine-learning model of the risk module, due diligence data of the property owner and the identified properties and the generated set of net lease terms, predicting, by the first machine-learning model, a plurality of risk probabilities associated with respective risk factors, running a gradient-based optimization process of the first machine-learning model to identify one or more combinations of net lease terms that minimize an overall risk level based on the predicted risk probabilities for the respective risk factors, and updating the generated net lease terms with changes based on the identified one or more combinations of net lease terms.

In some cases, the method further includes initiating, by the net lease module, an underwrite module, and inputting, in a second machine-learning model of the underwrite module, dynamic real-time due diligence data, and outputting, by the second machine-learning model, dynamic predictions of risk probabilities and mitigation recommendations, where the due diligence data includes at least some of the dynamic predictions of risk probabilities.

In some cases, the method further includes initiating, by the net lease module, a market module, and inputting, in a third machine-learning model of the market module, location data of respective real estate properties, market rate metrics associated with the location data, and due diligence data includes at least some of the dynamic predictions of risk probabilities, and outputting, by the third machine-learning model, pattern market data associated with the respective real estate properties based on the due diligence data.

In some cases, the method further includes initiating, by the net lease module, a financial module, and inputting, in a fourth machine-learning model of the financial module, at least one of the due diligence data, the outputted dynamic predictions of risk probabilities, the outputted pattern market data, and the location data of the respective real estate properties, and outputting, by the fourth machine-learning model, estimates of financial projections of a residential net lease for the respective real estate properties including at least one of a range for lease commitments to the property owner, a range for a yearly lease commitment increase, a range of fixed and variable costs, a range of rent that may be charged for the respective real estate properties, or a range of potential monthly profits.

In some cases, the method includes initiating, by the net lease module, a checklist module, and inputting, in a fifth machine-learning model of the checklist module, the estimates of financial projections, and outputting, by the fourth machine-learning model, weighted scores for rules associated with approving the set of net lease terms based on the estimates of financial projections.

In some cases, the first machine-learning model, the second machine-learning model, the third machine-learning model, the fourth machine-learning model, and the fifth machine-learning model are part of a neural network, and the method further includes retraining the neural network with new extracted data including at least one of new due diligence data, new dynamic real-time due diligence data, new identified properties, new risk probabilities, new risk factors, new market rate metrics, new pattern market data, or new estimates of financial projections.

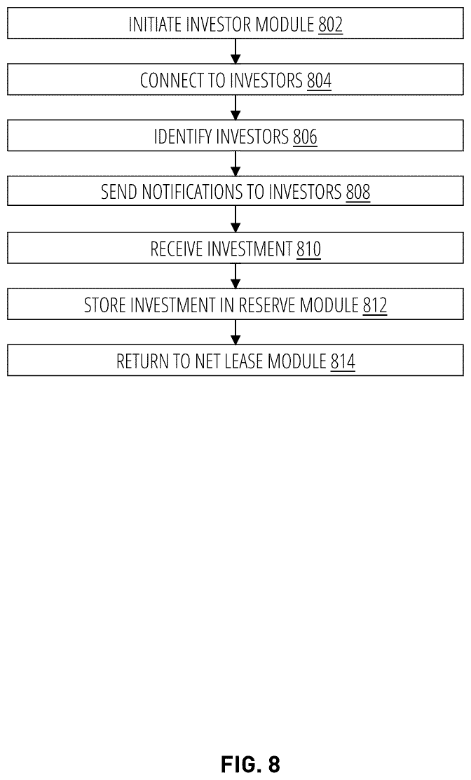

FIG. 8 displays an example method performed by the investor module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process begins with the investor module 122 being initiated, at step 802, by the net lease module 104. In some embodiments, the investor module 122 may not need to be initiated and is continuously running in the background of the net lease network 102. The investor module 122 connects, at step 804, to the checklist database 138. For example, the investor module 122 may connect to the checklist database 138 through the cloud 154, investors may log in to the net lease network 102, sign up to the net lease network 102, etc. In some embodiments, the investor module 122 may provide the checklist database 138 with certain documents such as income statements, balance sheets, capital requirements, investor agreements, term sheets, business plans, etc. The investor module 122 identifies, at step 806, potential investors for an investment into the reserve database 140. For example, the investor module 122 may identify potential investors for investment by collecting e-mails of investors that visit the net lease network 102, sign up for the net lease network 102 by creating a username and password, etc.

The investor module 122 sends, at step 808, a notification to the checklist database 138. For example, the investor module 122 may send an e-mail notification, notification through the net lease network 102, etc., to notify the investors. In some embodiments, the investor module 122 may provide the checklist database 138 with certain documents such as income statements, balance sheets, capital requirements, investor agreements, term sheets, business plans, etc.

The investor module 122 receives, at step 810, the investment from the checklist database 138. For example, the investor module 122 receives an investment from the investor 146, which may include a certain amount of capital to invest in the net lease agreements for residential rental properties. In some embodiments, the investor module 122 may send the investor 146 the investment agreement, contract, etc. The investor module 122 stores, at step 812, the received investment from the checklist database 138 in the reserve fund 24. For example, the investor module 122 stores the received investment in the reserve database 140 in which the checklist database 138 investment is stored as capital in the event that the net lease networks 102 expenses are greater than the returns, or profits from the residential rental properties, to ensure settlement of amount remunerated to the approval database 136 according to the terms of their net lease.

The owners database 132 may also be used to expand a line of credit for the net lease network 102 to add more residential rental properties to the lease database by attracting more approval database 136. An example owners database is provided below.

| Name | Owner ID | Property ID | Address | Square Footage | | Bedrooms | Bathrooms |
|---|---|---|---|---|---|---|---|
| John Smith | JS123 | JS123-001 | 123 main street, Boston, MA | 1,200 | sq. ft. | 2 | 1 |
| John Smith | JS123 | JS123-002 | 34 elm street, Boston, MA | 800 | sq. ft. | 1 | 1 |
| John Smith | JS123 | JS123-003 | 15 Maple Drive, Boston, MA | 1,500 | sq. ft. | 3 | 2 |

| | | | | | | |
|---|---|---|---|---|---|---|
| — | — | — | — | — | — | — |
| — | — | — | — | — | — | — |
| — | — | — | — | — | — | — |

The example owners database contains the list of owners interested in receiving net lease terms from the net lease network 102. The database contains the owner's name, the owner ID, the property ID, the property address, the square footage, the number of bedrooms, the number of bathrooms if the property or property owner 144 is approved for a residential net lease, and the property owner's 144 current status. In some embodiments, the owner may send the net lease network 102 more data on the location, such as average utility bills, property tax, insurance costs, condition of the property, condition of current appliances, etc.

In some embodiments, the owner may send the net lease network 102 the current rates they charge for rent, if the property is vacant or if it currently has renters, the application process the owner uses for renters, etc. In some embodiments, the approval status may be based on a per-property basis or on a per-property owner 144 basis. In some embodiments, the property owner's 144 current status may be the status of the investment of the residential net lease, including the profitability of the property, the overall revenue generated by the property, the fixed and variable costs of the property compared to similar properties in the region, cost of utility bills of the property compared to similar properties in the region, property tax of the property compared to similar properties in the region, insurance costs of the property compared to similar properties in the region, condition of the property compared to similar properties in the region, condition of current appliances of the property compared to similar properties in the region, etc.

The reserve fund may be funded entirely through the upfront fees paid by approval database 136. The calculation of the upfront fee paid by the property owner 144 may be based on an underwriting algorithm that identifies the relative risk of each property owner 144 and the market. In some embodiments, the reserve database 140 may be stored and managed by a third party, such as a bank or financial institution. In some embodiments, the reserve database 140 may be used for unexpected costs such as unexpected vacancy of the residential rental property, capital expenditures, variable costs, etc. The investor module 122 returns, at step 814, to the net lease module 104.

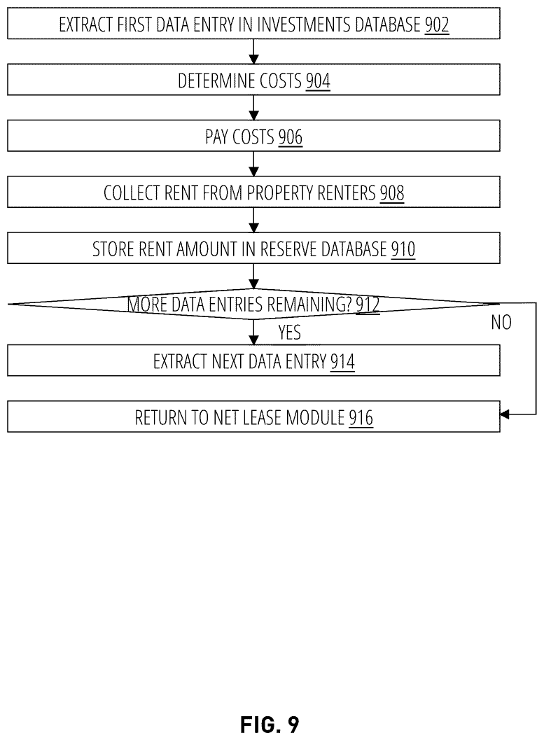

FIG. 9 displays an example method performed by the manage module. Although the example method depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

The process may begin with the manage module 124 being initiated by the net lease module 104. In some embodiments, the manage module 124 may not need to be initiated and is continuously running in the background of the net lease network 102. The manage module 124 extracts, at step 902, the first data entry in the lease database 130. For example, the manage module extracts the first data entry in the lease database 130, such as the first property, including The manage module 124 determines, at step 904, the fixed and variable costs for the property. For example, the manage module 124 may determine the fixed and variable costs for each of the properties, such as by invoices inputted by vendors 148 or by the property managers 142, extracting the operating expenses from the expenses database 128, etc. In some embodiments, the property manager 142 may be responsible for sending invoices of each property's fixed and variable costs, and the manage module 124 may extract the funds from the reserve database 140 to pay for the invoices.

The manage module 124 pays, at step 906, the costs of the property. For example, the manage module 124 may pay for the costs of the property by sending the payment from the reserve database 140 to the vendors 148 or property manager 142. In some embodiments, the vendors 148 or property manager 142 may submit invoices to be paid through the net lease network 102, and the manage module 124 extracts the payment from the reserve database 140 and sends the payment to the vendors 148 or property manager 142. The manage module 124 collects, at step 908, rent from the renters 150. For example, the manage module 124 may collect the rent from the residential rental properties by sending a notification to the property manager 142 or receiving a notification from the property manager 142 to determine if the rent for the rental property has been collected for the month. In some embodiments, the property manager 142 may use the manage module 124 or net lease network 102 to collect rent from the tenants, such as by the tenants signing into the net lease network 102 and sending the payment electronically.

The manage module 124 stores, at step 910, the rent in the reserve database 140. For example, the manage module 124 stores the rent collected and the amount collected for each rental property in the reserve database 140. In some embodiments, the rent may be stored in the reserve database 140 to be used to pay for the fixed and variable costs of the rental property. In some embodiments, the reserve database 140 may be used to pay for fixed or variable costs for other rental properties being managed by the net lease network 102. In some embodiments, the rent payment may be stored in the reserve database 140 by connecting the renter 150 to the net lease network 102 and submitting the payment, which is automatically transferred to the financial account of the reserve database 140. The manage module 124 determines, at decision block 912, if there are more data entries remaining in the lease database 130. For example, the manage module 124 extracts the next data entry to pay the next property's costs and collect the next property's rent until all of the properties in the lease database 130 have paid the associated property costs and collected rent from all of the renters 150. If it is determined that there are more data entries remaining in the lease database 130, the manage module 124 extracts, at step 914, the next data entry from the lease database 130. If it is determined that no more data entries remain in the lease database 130, the manage module 124 returns, at step 916, to the net lease module 104.

An example lease database is provided below.

| Property | | | | Lease | | | |
|---|---|---|---|---|---|---|---|
| Owner | Property | Lease | Lease | Payment | Fixed | Rent | Monthly |
| ID | ID | Length | Payment | Increase | Costs | Collected | Profits |
| JS123 | JS123-001 | 15 years | $2,000/month | 1% | $100/month | $2,500/month | $400 |
| JS123 | JS123-002 | 14 years | $2,200/month | 1% | $110/month | $2,700/month | $390 |
| JS123 | JS123-003 | 14 years | $1,800/month | 1.50% | $90/month | $2,300/month | $410 |
| — | — | — | — | — | — | — | — |
| TM456 | TM456-001 | 12 years | $3,000/month | 2% | $150/month | $3,700/month | $550 |
| TM456 | TM456-002 | 12 years | $2,500/month | 1.50% | $125/month | $3,200/month | $575 |
| TM456 | TM456-003 | 10 years | $2,800/month | 1.50% | $135/month | $3,400/month | $465 |
| — | — | — | — | — | — | — | — |
| HY789 | HY789-001 | 15 years | $2,300/month | 1% | $115/month | $2,900/month | $485 |
| HY789 | HY789-002 | 10 years | $2,200/month | 1% | $110/month | $2,800/month | $490 |
| HY789 | HY789-003 | 10 years | $2,500/month | 1.50% | $125/month | $3,100/month | $475 |
| — | — | — | — | — | — | — | — |
| — | — | — | — | — | — | — | — |
| — | — | — | — | — | — | — | — |

The example lease database contains a property owner ID, the property ID, the length of the lease or the years remaining on the net lease, the lease payment to the property owner 144, the annual increase of the net lease payment to the property owner, the fixed and variable costs per month for the property, the rent collected per month for the property, and the monthly profits for the property. In some embodiments, a property owner 144 may have multiple properties under a net lease with the net lease network 102. In some embodiments, the fixed and variable costs may differ for each property, or if there are multiple properties located within a certain radius, there may be one vendor 148 and/or one property manager 142 for each of the properties to lower the monthly fixed and variable costs. In some embodiments, the database may be shown as monthly, quarterly, or annual payments, expenses, profits, etc. In some embodiments, the investors 146 may receive a percentage of the monthly profits or may be paid out based on quarterly or annual profits.

In some cases, the accounting module 126 may be initiated by the net lease module 104. In some embodiments, the accounting module 126 may not need to be initiated and is continuously running in the background of the net lease network 102. The accounting module 126 determines the payment to the property owners 144. For example, the accounting module 126 may determine the payment to the property owner 144 by extracting the net lease payment from the lease database 130 and extracting the amount from the reserve database 140 to send to the property owner 144. In some embodiments, if a property owner 144 has multiple properties on the net lease network 102, the accounting module 126 may filter the lease database 130 on the property owner 144 ID and determine the sum of all the net lease payments owed to the property owner 144 and extract the funds from the reserve database 140 to send to the property owner 144. In some embodiments, if there is a plurality of property owners 144, the accounting module 126 may extract a first property owner 144 and determine the payment, send the payment, and then select the next property owner 144 until all the property owners 144 are stored in the lease database 130 are paid. In some embodiments, the payments may be determined by the net lease terms and sent based on a specific schedule, and may be paid out monthly, quarterly, annually, etc.

The accounting module 126 sends the payment to the property owners 144. For example, the accounting module 126 may send the net lease payment to the property owner 144 by extracting the amount owed to the property owner 144 from the reserve database 140 and sending the payment electronically to the property owner 144. The accounting module 126 determines, at step 1306, the profits of the residential investments. For example, the accounting module 126 may determine the profits of the residential investments by extracting the payment to the property owners 144, the cost of the properties, and the rent collected on the property. Then the accounting module 126 may add the payment to the property owners and the cost of the property together and subtract the total from the rent collected to determine the monthly profit of the property. The accounting module 126 may add the sum of all the profits for the residential rental properties to determine the total profit. In some embodiments, the profits may be stored in the lease database 130. In some embodiments, the profits may be determined monthly, quarterly, annually, etc.

The accounting module 126 sends, at step 1308, the profits of the residential investments to the investors 146. For example, the accounting module 126 may send the profits to investors 146 that had invested in the net lease network 102. For example, the investors 146 may have a certain percentage of profits they are entitled to based upon their investor agreement. For example, if an investor 146 agreed to invest $1,000 for 1% of the profits and the total monthly profits were $4,000, then the investor 146 would be entitled to $40 for the monthly profits. In some embodiments, the investor agreements may be stored in the net lease network 102. In some embodiments, the accounting module 126 may extract each investor 146 agreement and the percentages of the profits that they are owed and extract the amount from the reserve database 140 to pay the investors 146 their return on investment. In some embodiments, the investors 146 may be paid out monthly, quarterly, annually, etc. The accounting module 126 returns, at step 1310, to the net lease module 104.

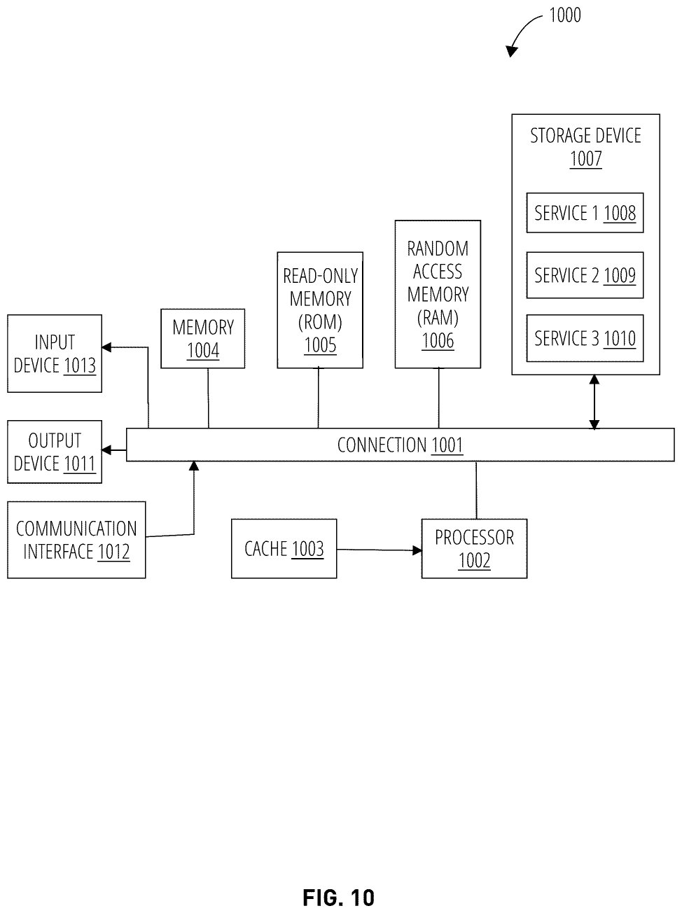

FIG. 10 illustrates a block diagram of an exemplary computing system that may be used to implement an embodiment of the present invention. The example of computer system 1000 can be for example any computing device making up 100, or any component thereof in which the components of the system are in communication with each other using connection 1001. Connection 1001 can be a physical connection via a bus, or a direct connection into processor 1002, such as in a chipset architecture. Connection 1001 can also be a virtual connection, networked connection, or logical connection.

In some embodiments, computing computer system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing computer system 1000 includes at least one processing unit (CPU or processor) 1002 and connection 1001 that couples various system components including system memory 1004, such as read-only memory (ROM) 1005 and random access memory (RAM) 1006 to processor 1002. Computing system 500 can include a cache of high-speed memory 1004 connected directly with, in close proximity to, or integrated as part of processor 1002.

Processor 1002 can include any general purpose processor and a hardware service or software service, such as services 1008, 1009, and 1010 stored in storage devices 1007, configured to control processor 1002 as well as a special-purpose processor where software instructions are incorporated into the actual processor design. Processor 1002 may essentially be a completely self-contained computing system, containing multiple cores or processors, a bus, memory controller, cache, etc. A multi-core processor may be symmetric or asymmetric.

To enable user interaction, computing computer system 1000 includes an input device 1013, which can represent any number of input mechanisms, such as a microphone for speech, a touch-sensitive screen for gesture or graphical input, keyboard, mouse, motion input, speech, etc. Computing system 1000 can also include output device 1011, which can be one or more of a number of output mechanisms known to those of skill in the art. In some instances, multimodal systems can enable a user to provide multiple types of input/output to communicate with computer system 1000. Computing system 1000 can include communication interface 1012, which can generally govern and manage the user input and system output. There is no restriction on operating on any particular hardware arrangement, and therefore the basic features here may easily be substituted for improved hardware or firmware arrangements as they are developed.

Storage device 1007 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1007 can include software services, servers, services, etc., that when the code that defines such software is executed by the processor 1002, it causes the system to perform a function. In some embodiments, a hardware service that performs a particular function can include the software component stored in a computer-readable medium in connection with the hardware components, such as processor 1002, connection 1001, output device 1011, etc., to carry out the function.

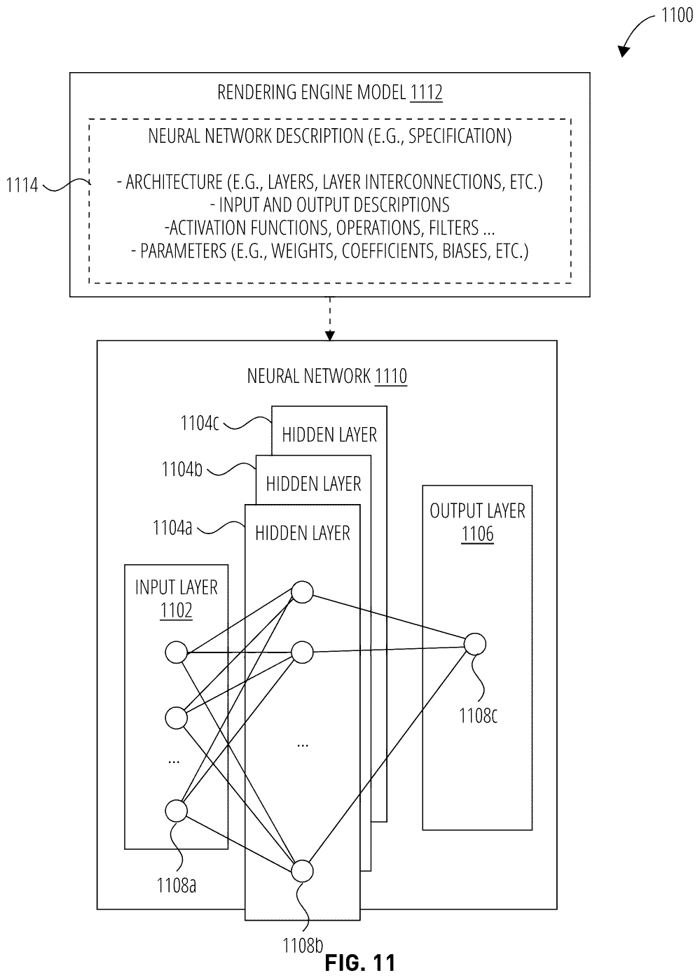

FIG. 11 illustrates an example neural network architecture.

Architecture 1100 includes a neural network 1104c defined by an example neural network description 1108a in node 1110c (neural controller). The neural network 6100 can represent a neural network implementation of a rendering engine for rendering media data. The neural network description 1108a can include a full specification of the neural network 1104c, including the neural network architecture 1100. For example, the neural network description 1108a can include a description or specification of the architecture 1100 of the neural network 1104c (e.g., the layers, layer interconnections, number of nodes in each layer, etc.); an input and output description which indicates how the input and output are formed or processed; an indication of the activation functions in the neural network, the operations or filters in the neural network, etc.; neural network parameters such as weights, biases, etc.; and so forth.

The neural network 1104c reflects the architecture 1100 defined in the input layer 1102. In this example, the neural network 1104c includes an input layer 1102, which includes input data, such fixed costs and variable costs, due diligence data of the property owner and the identified properties and the generated set of net lease terms, dynamic real-time due diligence data, dynamic predictions of risk probabilities and mitigation recommendations, location data of respective real estate properties, market rate metrics associated with the location data, due diligence data includes at least some of the dynamic predictions of risk probabilities, at least one of the due diligence data, the outputted dynamic predictions of risk probabilities, the outputted pattern market data, and the location data of the respective real estate properties, identified one or more combinations of net lease terms, a plurality of risk probabilities associated with respective risk factors, and dynamic predictions of risk probabilities and mitigation recommendations. In one illustrative example, the input layer 1102 can include data representing a portion of the input data. The neural network 1104c includes hidden layers 504a through 604N (collectively “604” hereinafter). The hidden layers 604 can include n number of hidden layers, where n is an integer greater than or equal to one. The number of hidden layers can include as many layers as needed for a desired processing outcome and/or rendering intent.

The neural network 1104c further includes an output layer 1104b that provides an output resulting from the processing performed by the hidden layers 604. In one illustrative example, the output layer 1104b can provide pattern market data associated with the respective real estate properties based on the due diligence data. The neural network 1104c in this example is a multi-layer neural network of interconnected nodes. Each node can represent a piece of information. Information associated with the nodes is shared among the different layers and each layer retains information as information is processed. In some cases, the neural network 1104c can include a feed-forward neural network, in which case there are no feedback connections where outputs of the neural network are fed back into itself. In other cases, the neural network 1104c can include a recurrent neural network, which can have loops that allow information to be carried across nodes while reading in input. Information can be exchanged between nodes through node-to-node interconnections between the various layers.

Nodes of the input layer 1102 can activate a set of nodes in the first hidden layer 504a. For example, as shown, each of the input nodes of the input layer 1102 is connected to each of the nodes of the first hidden layer 504a. The nodes of the hidden layers hidden layer 504a can transform the information of each input node by applying activation functions to the information. The information derived from the transformation can then be passed to and can activate the nodes of the next hidden layer (e.g., 504b), which can perform their own designated functions. Example functions include convolutional, up-sampling, data transformation, pooling, and/or any other suitable functions. The output of the hidden layer (e.g., 504b) can then activate nodes of the next hidden layer (e.g., 604N), and so on. The output of the last hidden layer can activate one or more nodes of the output layer 1104b, at which point an output is provided. In some cases, while nodes (e.g., nodes 508a, 508b, 508c) in the neural network 1104c are shown as having multiple output lines, a node has a single output and all lines shown as being output from a node represent the same output value. In some cases, each node or interconnection between nodes can have a weight that is a set of parameters derived from training the neural network 1104c.

For example, an interconnection between nodes can represent a piece of information learned about the interconnected nodes. The interconnection can have a numeric weight that can be tuned (e.g., based on a training dataset), allowing the neural network 1104c to be adaptive to inputs and able to learn as more data is processed. The neural network 1104c can be pre-trained to process the features from the data in the input layer 1102 using the different hidden layers 604 in order to provide the output through the output layer 1104b. The neural network 1104c can be trained using training data that includes example fixed costs and variable costs, due diligence data of the property owner and the identified properties and the generated set of net lease terms, dynamic real-time due diligence data, dynamic predictions of risk probabilities and mitigation recommendations, location data of respective real estate properties, market rate metrics associated with the location data, due diligence data includes at least some of the dynamic predictions of risk probabilities, at least one of the due diligence data, the outputted dynamic predictions of risk probabilities, the outputted pattern market data, and the location data of the respective real estate properties, identified one or more combinations of net lease terms, a plurality of risk probabilities associated with respective risk factors, and dynamic predictions of risk probabilities and mitigation recommendations. For instance, training images can be input into the neural network 1104c, which can be processed by the neural network 1104c to generate outputs which can be used to tune one or more aspects of the neural network 1104c, such as weights, biases, etc. In some cases, the neural network 1104c can adjust weights of nodes using a training process called backpropagation. Backpropagation can include a forward pass, a loss function, a backward pass, and a weight update. The forward pass, loss function, backward pass, and parameter update is performed for one training iteration.

The process can be repeated for a certain number of iterations for each set of training media data until the weights of the layers are accurately tuned. For a first training iteration for the neural network 1104c, the output can include values that do not give preference to any particular class due to the weights being randomly selected at initialization. For example, if the output is a vector with probabilities that the object includes different product(s) and/or different users, the probability value for each of the different product and/or user may be equal or at least very similar (e.g., for ten possible products or users, each class may have a probability value of 0.1). With the initial weights, the neural network 1104c is unable to determine low level features and thus cannot make an accurate determination of what the classification of the object might be. A loss function can be used to analyze errors in the output. Any suitable loss function definition can be used. The loss (or error) can be high for the first training dataset (e.g., images) since the actual values will be different than the predicted output.

The goal of training is to minimize the amount of loss so that the predicted output comports with a target or ideal output. The neural network 1104c can perform a backward pass by determining which inputs (weights) most contributed to the loss of the neural network 1104c, and can adjust the weights so that the loss decreases and is eventually minimized. A derivative of the loss with respect to the weights can be computed to determine the weights that contributed most to the loss of the neural network 1104c. After the derivative is computed, a weight update can be performed by updating the weights of the filters. For example, the weights can be updated so that they change in the opposite direction of the gradient. A learning rate can be set to any suitable value, with a high learning rate including larger weight updates and a lower value indicating smaller weight updates.

The neural network 1104c can include any suitable neural or deep learning network. One example includes a convolutional neural network (CNN), which includes an input layer and an output layer, with multiple hidden layers between the input and out layers. The hidden layers of a CNN include a series of convolutional, nonlinear, pooling (for downsampling), and fully connected layers. In other examples, the neural network 1104c can represent any other neural or deep learning network, such as an autoencoder, a deep belief nets (DBNs), a recurrent neural networks (RNNs), etc.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some aspects, a service can be software that resides in memory of a client device and/or one or more servers of a content management system and perform one or more functions when a processor executes the software associated with the service. In some aspects, a service is a program or a collection of programs that carry out a specific function. In some aspects, a service can be considered a server. The memory can be a non-transitory computer-readable medium.

In some aspects, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general-purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

What is claimed is:

1. A computer-implemented method of automating a residential net lease management tool that update net lease terms to minimize an overall risk level based on predicted risk probabilities for risk factors, comprising:
receiving, over an expense network, market data associated with a specific region sent over a communication network at a net lease management server configured to communicate with at least one third-party application;
initiating, by a net lease module, a reserve module;
generating, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiating, by the net lease module, an owner module;
identifying, by the owner module, properties that fall within the net lease parameters generated by the reserve module;
initiating, by the net lease module, a manage module;
determining, by the manage module, fixed costs and variable costs based on data associated with at least one of the identified properties and extracted data points from stored invoice data;
generating, by the reserve module, a set of net lease terms associated with the at least one of the properties identified by the net lease module, based on first inputs including the fixed costs and variable costs determined the manage module, wherein first weights are assigned to each first input;
receiving an approval from a property owner of the generated set of net lease terms;
initiating, by the net lease module, a risk module;
inputting, in a first machine-learning model of the risk module, due diligence data of the property owner and the identified properties and the generated set of net lease terms;
predicting, by the first machine-learning model, a plurality of risk probabilities associated with respective risk factors;
running a gradient-based optimization process of the first machine-learning model to identify one or more combinations of the net lease terms that minimize an overall risk level based on the predicted risk probabilities for the respective risk factors; and
updating the generated net lease terms with changes based on the identified one or more combinations of net lease terms.

2. The computer-implemented method of claim 1, further comprising:
initiating, by the net lease module, an underwrite module;
inputting, in a second machine-learning model of the underwrite module, dynamic real-time due diligence data; and
outputting, by the second machine-learning model, dynamic predictions of risk probabilities and mitigation recommendations, wherein the due diligence data includes at least some of the dynamic real-time due diligence data.

3. The computer-implemented method of claim 2, further comprising:
initiating, by the net lease module, a market module;
inputting, in a third machine-learning model of the market module, location data of respective real estate properties, market rate metrics associated with the location data, and due diligence data includes at least some of the dynamic predictions of risk probabilities; and
outputting, by the third machine-learning model, pattern market data associated with the respective real estate properties based on the due diligence data.

4. The computer-implemented method of claim 3, further comprising:
initiating, by the net lease module, a financial module;
inputting, in a fourth machine-learning model of the financial module, at least one of the due diligence data, the outputted dynamic predictions of risk probabilities, the outputted pattern market data, and the location data of the respective real estate properties; and
outputting, by the fourth machine-learning model, estimates of financial projections of a residential net lease for the respective real estate properties including at least one of a range for lease commitments to the property owner, a range for a yearly lease commitment increase, a range of fixed and variable costs, a range of rent that may be charged for the respective real estate properties, or a range of potential monthly profits.

5. The computer-implemented method of claim 4, further comprising:
initiating, by the net lease module, a checklist module;
inputting, in a fifth machine-learning model of the checklist module, the estimates of financial projections; and
outputting, by the fourth machine-learning model, weighted scores for rules associated with approving the set of net lease terms based on the estimates of financial projections.

6. The computer-implemented method of claim 5, wherein the first machine-learning model, the second machine-learning model, the third machine-learning model, the fourth machine-learning model, and the fifth machine-learning model are part of a neural network, and further comprising:
retraining the neural network with new extracted data including at least one of new due diligence data, new dynamic real-time due diligence data, new identified properties, new risk probabilities, new risk factors, new market rate metrics, new pattern market data, or new estimates of financial projections.

7. The computer-implemented method of claim 1, further comprising:
using a second machine-learning model to output the set of net lease terms, and wherein the second machine-learning model determines the first weights based on training data including past net lease terms associated with the one or more regions.

8. The computer-implemented method of claim 1, further comprising:
performing one or more simulations for comparable net lease terms and comparable financial planning data; and
based on the performed simulations, causing to presenting one or more options of changes to the approved net lease terms and the financial planning data based on better risk-return projections for the comparable net lease terms and the comparable financial planning data.

9. The computer-implemented method of claim 1, further comprising:
recording, by an accounting module in a reserve database associated with a single reserve fund, a first accounting for a first amount funded by one or more investors that are not the respective owners;
recording, by the accounting module in the reserve database associated with the single reserve fund, a second accounting for a second amount remunerated to the investors based on determined profit margins over term of lease and the net lease terms stored at the lease database; and
sending, based upon the accountings of the reserve database over the communication network, an instruction to trigger a transfer to the single reserve fund.

10. The computer-implemented method of claim 1, wherein the market data includes at least one of starting market rent, market growth rate, inflation rate, vacancy rate, rent collectability rate, home price appreciation, operating expenses, local taxes, insurance rates, management amounts, maintenance budget, homeowner's association amounts, cost of utilities, or asset management amounts.

11. The computer-implemented method of claim 1, wherein the inputs include at least one of average rent in the one or more regions, square footage of the respective property, market growth rate, inflation rate, vacancy rate, rent collectability rate, home price appreciation, or operating expenses.

12. A system for automating a residential net lease management tool that update net lease terms to minimize an overall risk level based on predicted risk probabilities for risk factors, comprising:
a storage configured to store instructions;
a net lease module that controls a reserve module, an owner module, a manage module, and a risk module;
the reserve module that generates a plurality of net lease parameters for different regions;
the owner module that identifies replacement properties that fall within a particular net lease parameter;
the manage module that determines fixed costs and variable costs; and
the risk module that identifies prospective net lease terms that minimize an overall risk level based on predicted risk probabilities for respective risk factors;
one or more processors configured to execute the instructions and cause the one or more processors to:
receive, over an expense network, market data associated with a specific region sent over a communication network at a net lease management server configured to communicate with at least one third-party application;
initiate, by the net lease module, the reserve module;
generate, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiate, by the net lease module, the owner module;
identify, by the owner module, properties that fall within the net lease parameters generated by the reserve module;
initiate, by the net lease module, the manage module;
determine, by the manage module, fixed costs and variable costs based on data associated with at least one of the identified properties and extracted data points from stored invoice data;
generate, by the reserve module, a set of net lease terms associated with the at least one of the properties identified by the net lease module, based on inputs including the fixed costs and variable costs determined the manage module, wherein weights are assigned to each input;
receive an approval from a property owner of the generated set of net lease terms;
initiate, by the net lease module, the risk module;
input, in a first machine-learning model of the risk module, due diligence data of the property owner and the identified properties and the generated set of net lease terms;
predict, by the first machine-learning model, a plurality of risk probabilities associated with respective risk factors;
run a gradient-based optimization process of the first machine-learning model to identify one or more combinations of net lease terms that minimize an overall risk level based on the predicted risk probabilities for the respective risk factors; and
update the generated net lease terms with changes based on the identified one or more combinations of net lease terms.

13. The system of claim 12, wherein the inputs include at least one of average rent in the one or more regions, square footage of the respective property, market growth rate, inflation rate, vacancy rate, rent collectability rate, home price appreciation, or operating expenses.

14. The system of claim 12, wherein the one or more processors are configured to execute the instructions and cause the one or more processors to:
initiate, by the net lease module, an underwrite module;
input, in a second machine-learning model of the underwrite module, dynamic real-time due diligence data; and
output, by the second machine-learning model, dynamic predictions of risk probabilities and mitigation recommendations, wherein the due diligence data includes at least some of the dynamic predictions of risk probabilities.

15. The system of claim 14, wherein the one or more processors are configured to execute the instructions and cause the one or more processors to:
initiating, by the net lease module, a market module;
inputting, in a third machine-learning model of the market module, location data of respective real estate properties, market rate metrics associated with the location data, and due diligence data includes at least some of the dynamic predictions of risk probabilities; and
outputting, by the third machine-learning model, pattern market data associated with the respective real estate properties based on the due diligence data.

16. The system of claim 15, wherein the one or more processors are configured to execute the instructions and cause the one or more processors to:
initiating, by the net lease module, a financial module;
inputting, in a fourth machine-learning model of the financial module, at least one of the due diligence data, the outputted dynamic predictions of risk probabilities, the outputted pattern market data, and the location data of the respective real estate properties; and
outputting, by the fourth machine-learning model, estimates of financial projections of a residential net lease for the respective real estate properties including at least one of a range for lease commitments to the property owner, a range for a yearly lease commitment increase, a range of fixed and variable costs, a range of rent that may be charged for the respective real estate properties, or a range of potential monthly profits.

17. The system of claim 16, wherein the one or more processors are configured to execute the instructions and cause the one or more processors to:
initiating, by the net lease module, a checklist module;
inputting, in a fifth machine-learning model of the checklist module, the estimates of financial projections; and
output, by the fourth machine-learning model, weighted scores for rules associated with approving the set of net lease terms based on the estimates of financial projections.

18. The system of claim 17, wherein the first machine-learning model, the second machine-learning model, the third machine-learning model, the fourth machine-learning model, and the fifth machine-learning model are part of a neural network, and further comprising:
retrain the neural network with new extracted data including at least one of new due diligence data, new dynamic real-time due diligence data, new identified properties, new risk probabilities, new risk factors, new market rate metrics, new pattern market data, or new estimates of financial projections.

19. The system of claim 12, wherein the one or more processors are configured to execute the instructions and cause the one or more processors to:
use a second machine-learning model to output the set of net lease terms, and wherein the second machine-learning model determines the weights based on training data including past net lease terms associated with the one or more regions.

20. A non-transitory computer readable medium comprising instructions, the instructions, when executed by a computing system, cause the computing system to:
receive, over an expense network, market data associated with a specific region sent over a communication network at a net lease management server configured to communicate with at least one third-party application;
initiate, by a net lease module, a reserve module;
generate, by the reserve module, net lease parameters for the specific region based on a calculated profitability evaluation based on the market data received via the expense network, wherein the calculated profitability evaluation determines a threshold margin based on a percentage of an average rental rate and average fixed costs in the specific region;
initiate, by the net lease module, an owner module;
identify, by the owner module, properties that fall within the net lease parameters generated by the reserve module;
initiate, by the net lease module, a manage module;
determine, by the manage module, fixed costs and variable costs based on data associated with at least one of the identified properties and extracted data points from stored invoice data;
generate, by the reserve module, a set of net lease terms associated with the at least one of the properties identified by the net lease module, based on first inputs including the fixed costs and variable costs determined the manage module, wherein first weights are assigned to each first input;
receive an approval from a property owner of the generated set of net lease terms;
initiate, by the net lease module, a risk module;
input, in a first machine-learning model of the risk module, due diligence data of the property owner and the identified properties and the generated set of net lease terms;
predict, by the first machine-learning model, a plurality of risk probabilities associated with respective risk factors;
run a gradient-based optimization process of the first machine-learning model to identify one or more combinations of net lease terms that minimize an overall risk level based on the predicted risk probabilities for the respective risk factors; and
update the generated net lease terms with changes based on the identified one or more combinations of net lease terms.
